(19) United States
(12) Patent Application Publication
(10) Pub. No.: US 2026/0289348 A1
(43) Pub. Date: Sep. 24, 2026

(54) SYSTEM

(71) Applicant: SoftBank Group Corp., Tokyo (JP)

(72) Inventor: Takahiro YANAGIDA, Tokyo (JP)

(73) Assignee: SoftBank Group Corp., Tokyo (JP)

(21) Appl. No.: 19/565,609

(22) Filed: Mar. 13, 2026

(30) Foreign Application Priority Data
Mar. 19, 2025 (JP) 2025-045151

(51) Int. Cl. G06N 5/04

(52) U.S. Cl. CPC G06N 5/04

(57) ABSTRACT

A system includes a processor that is configured to provide a personalized artificial intelligence assistant to each individual user, analyze a prompt sentence by using a generative artificial intelligence model and select an appropriate service based on a result of the analysis, and evaluate an emotional state of the user by using an emotion analysis engine and adjust provision of the service based on a result of the evaluation.

### CROSS-REFERENCE TO RELATED APPLICATION

This application is based on and claims priority under 35 USC 119 from Japanese Patent Application No. 2025-045151 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting office work and personnel management typically provide only generic task management, messaging functions, or simple rule-based assistants that do not sufficiently adapt to individual users. Such systems often fail to understand nuanced user intentions described in natural language, and they cannot flexibly select or combine services in response to those intentions. Furthermore, conventional systems rarely consider the emotional state of the user when providing services, which may lead to inappropriate timing, tone, or level of support, thereby reducing user satisfaction and effectiveness. In addition, managers generally have limited, fragmented, or delayed visibility into the work situation of subordinates, and they lack tools that synthesize information from subordinates' digital behavior in a unified and comprehensible form. Conventional reporting tools also do not exploit interaction between personalized artificial intelligence assistants across hierarchical levels to derive organization-wide strengths and weaknesses. As a result, it is difficult for an organization to achieve both individualized support for each user and systematic, real-time insight into team and organizational performance.

### SUMMARY

In order to solve the above problems, an aspect of the present invention provides a system comprising a processor, wherein the processor is configured to provide a personalized artificial intelligence assistant to each individual user, analyze a prompt sentence by using a generative artificial intelligence model and select an appropriate service based on a result of the analysis, and evaluate an emotional state of the user by using an emotion analysis engine and adjust provision of the service based on a result of the evaluation. According to this configuration, the processor interprets user inputs expressed in natural language and dynamically chooses among multiple services, such as schedule management, task assistance, information retrieval, or career guidance, while adapting the content and manner of service delivery to the user's emotional state. In another aspect, the processor is further configured to enable a supervisor to grasp a work situation of a subordinate in an overview manner through an artificial intelligence assistant of the subordinate, thereby allowing the supervisor to monitor progress, workload, and other status indicators in a comprehensive and timely way. In still another aspect, the processor is configured to grasp strengths and weaknesses of an organization by causing individualized subordinate artificial intelligence assistants and supervisor artificial intelligence assistants to contact with each other inside and outside of working hours, aggregate and analyze information obtained through such contacts, and thereby generate insights at the organizational level.

The term “system” refers to an arrangement of hardware and software components including at least one processor and associated memory, storage, and communication interfaces, which cooperate to execute the functions described in the claims.

The term “processor” refers to one or more hardware processing units, such as a central processing unit (CPU), a graphics processing unit (GPU), a digital signal processor (DSP), or a combination thereof, that execute instructions to perform the operations specified in the claims.

The term “user” refers to any individual person who interacts with the system, including but not limited to employees, staff members, workers, or other personnel who receive services from a personalized artificial intelligence assistant provided by the system.

The term “personalized artificial intelligence assistant” refers to a software-based agent executed by the system that is associated with a specific user, that maintains user-specific information such as preferences, history, and context, and that provides services tailored to that particular user by using artificial intelligence techniques.

The term “generative artificial intelligence model” refers to a machine learning model, such as a large language model or other generative model, that is trained on data to generate or transform content, including but not limited to analyzing and responding to natural language prompt sentences provided by the user.

The term “prompt sentence” refers to a natural language input, which may include one or more sentences, commands, questions, or instructions, that is provided by the user to the system and that is analyzed by the generative artificial intelligence model in order to determine an appropriate service to be executed.

The term “service” refers to a function or operation performed by the system in response to analysis of the prompt sentence, including but not limited to schedule management, task handling, information retrieval, reporting, recommendation, or any other user-support function.

The term “emotion analysis engine” refers to a software component, which may use machine learning, rule-based analysis, or a combination thereof, that estimates or classifies an emotional state of the user based on input data such as text, voice, physiological signals, or interaction patterns.

The term “emotional state of the user” refers to an internal condition of the user, such as stress, satisfaction, frustration, motivation, or calmness, that is inferred or categorized by the emotion analysis engine and used by the system to adjust the provision of services.

The term “adjust provision of the service” refers to modifying at least one aspect of how a service is delivered to the user, such as timing, frequency, content, tone, presentation format, priority, or level of detail, in accordance with the evaluated emotional state of the user.

The term “supervisor” refers to a user who has managerial or oversight responsibility for at least one subordinate, and who is authorized by the system to access overview information regarding the work situation of the subordinate.

The term “subordinate” refers to a user who is associated with a supervisor in an organizational hierarchy and whose work situation is at least partially visible to the supervisor through the subordinate's personalized artificial intelligence assistant.

The term “artificial intelligence assistant of the subordinate” refers to the personalized artificial intelligence assistant that is associated with a subordinate and that collects, manages, or generates information related to the subordinate's work situation.

The term “work situation” refers to a status of the subordinate's work activities, including but not limited to task progress, workload, deadlines, performance indicators, and other operational metrics that can be derived or summarized by the system.

The term “in an overview manner” refers to a form of presentation in which the supervisor is provided with summarized, aggregated, or otherwise abstracted information about the subordinate's work situation, rather than only raw or detailed data, so that the supervisor can quickly grasp the overall state.

The term “individualized subordinate artificial intelligence assistants and supervisor artificial intelligence assistants” refers to respective personalized artificial intelligence assistants that are associated with individual subordinate users and supervisor users, and that operate with user-specific contexts reflecting their roles and relationships in the organization.

The term “contact with each other” refers to an exchange of data or messages between the individualized subordinate artificial intelligence assistants and supervisor artificial intelligence assistants, which may occur through direct communication, mediated communication via the processor, or shared data structures within the system.

The term “inside and outside of working hours” refers to time periods that include both designated working time and non-working time as defined by organizational or contractual rules, such that communication and analysis by the artificial intelligence assistants are not restricted solely to official working hours.

The term “strengths and weaknesses of an organization” refers to advantageous and disadvantageous characteristics of the organization, such as efficiency, responsiveness, collaboration quality, bottlenecks, or areas needing improvement, which are derived from aggregated information obtained through interactions between the individualized artificial intelligence assistants.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

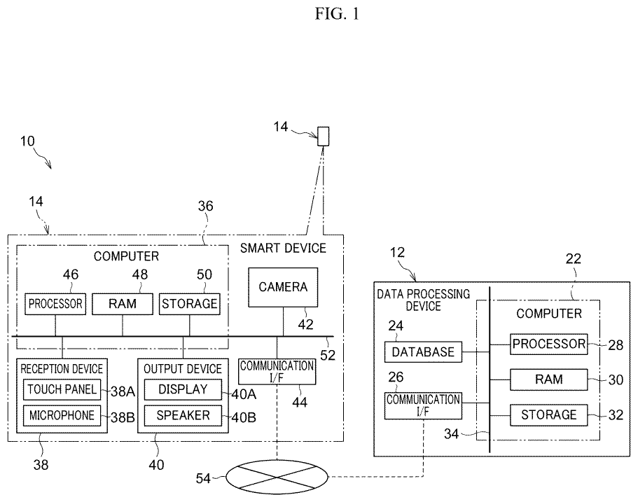

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

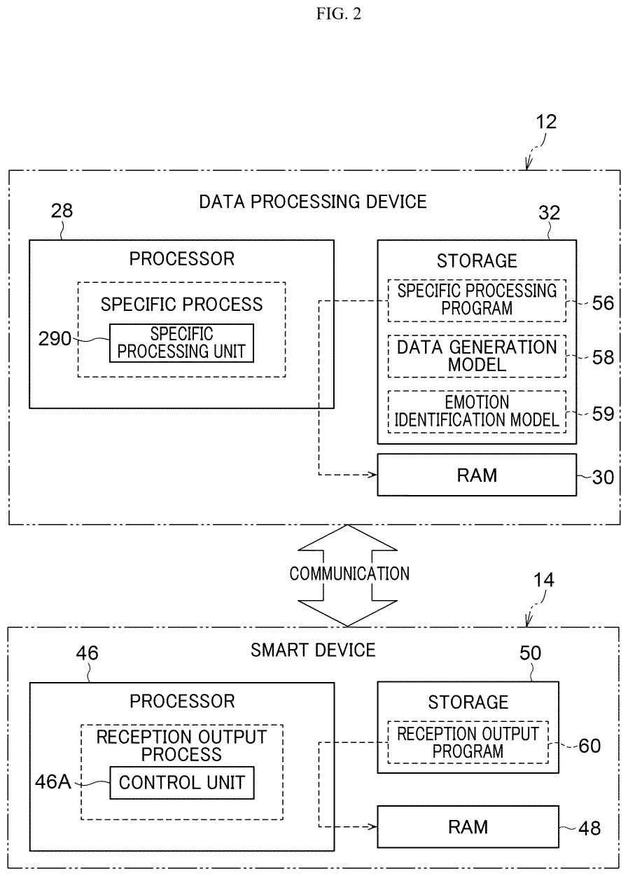

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In enterprise environments, conventional computer-implemented assistant systems typically process user requests as isolated, single-turn commands. Such systems often employ simple rule-based intent classification, fixed workflows, and static user interfaces. As a result, these systems suffer from several technical limitations.

First, conventional systems lack a unified control structure for coordinating multiple heterogeneous processing flows such as schedule management, notification control, information retrieval, work support, and job advice. Intent determination, external service invocation, and response generation are often implemented as disjoint modules, leading to redundant parsing, inefficient API usage, and increased latency. There is no single, dynamically generated control object that consistently drives downstream processing based on rich context.

Second, existing systems generally do not leverage generative AI models as a central orchestration engine that can both (i) convert natural language input into structured, machine-actionable representations and (ii) generate tailored natural language responses using the same semantic context. Instead, natural language understanding and response generation are fragmented across different components, which results in brittle integrations, decreased robustness to ambiguous input, and increased complexity in maintaining the parsing logic.

Third, known systems typically maintain only limited user attribute information or organizational attribute information, and do not integrate such information into prompt sentences for generative AI models in a systematic way. Without structured integration of user attributes (such as role, skills, preferences) and organization attributes (such as policies, team structure) into the control information passed to the model, the system cannot technically realize highly personalized, context-aware behavior at scale. This leads to sub-optimal scheduling, generic recommendations, and inefficient use of computing resources due to unnecessary follow-up requests and repeated clarification.

Fourth, conventional architectures generally treat emotion analysis, if present at all, as an auxiliary feature divorced from the main control flow. Emotion state estimation is not tightly coupled to the generation of response information and notification control information. As a consequence, the system cannot technically adapt the content and expression style of responses, or the timing and modality of notifications, in a manner that reduces cognitive load or improves user interaction efficiency.

Fifth, existing systems usually log user interactions but do not aggregate input information, structured intent information, and response information across multiple users into machine-processable work status index information and organization-wide characteristic information. In particular, they do not provide a technical mechanism by which higher-level users can obtain, via a management terminal, an overview of team-wide work status and organizational strengths and weaknesses derived from the operation of multiple artificial intelligence assistants. This leads to fragmented data silos, inefficient computation of organizational metrics, and inability to algorithmically optimize team-level workflows.

Sixth, conventional assistant systems associated with individual users rarely implement coordinated inter-assistant communication. They lack a processor-controlled mechanism for causing multiple artificial intelligence assistant functions to mutually link schedule information, work support processing result information, and job advice processing result information across work and non-work periods, in order to extract organization-level strength and weakness information. Without such coordinated linking, the system cannot technically synthesize cross-user patterns that could be used to optimize scheduling, load balancing, and human-computer interaction strategies at the organizational scale.

Accordingly, there is a need for an improved computer-implemented system that (i) integrates natural language input, user and organization attributes, and generative AI models through a unified prompt-based control information structure; (ii) automatically selects and orchestrates diverse processing flows, including external information sources, based on structured intent information; (iii) dynamically adapts responses and notifications using emotion state information; and (iv) aggregates and analyzes multi-user interaction data to compute work status index information and organization-wide characteristic information, thereby technically improving the functioning of the computer system as a whole in terms of robustness, scalability, responsiveness, and manageability.

The specific processing by the specific processing unit 290 of the data processing device 12 in Example 1 is realized by the following means.

The present invention provides a server comprising a processor and a memory storing instructions which, when executed by the processor, cause the processor to acquire input information including a natural language request received from a user via a terminal, and user attribute information and organization attribute information associated with the user; to generate control information by integrating a prompt sentence including the input information with the user attribute information and the organization attribute information, to input the control information to a generative AI model, and to obtain structured information including intent information of the request and processing type information corresponding to the request; to select, on the basis of the processing type information included in the structured information, at least one processing from among schedule management processing, notification control processing, information retrieval processing, work support processing, and job advice processing, and to acquire at least one information from among schedule information, communication information, and knowledge information via an information acquisition interface provided by an external information providing apparatus; to configure a prompt sentence for generation of response data on the basis of the acquired schedule information, communication information, and knowledge information and the user attribute information, and to input the prompt sentence to the generative AI model to cause the generative AI model to generate response information in natural language; to generate display control information to be displayed on the terminal and notification control information to be transmitted to the terminal, on the basis of the response information; to aggregate, in a management information processing function associated with a higher-level user, the input information, the structured information, and the response information corresponding to a plurality of users to generate work status index information, and to calculate organization-wide characteristic information on the basis of the work status index information; and to estimate emotion state information of the user from the input information by an emotion analysis processing apparatus configured to implement an emotion analysis function, and to change contents and expression style of the response information and the notification control information in accordance with the emotion state information. This enables the computer system to perform improved technical processing by using a unified, prompt-based control information structure that coordinates intent analysis, external information acquisition, personalized response generation, emotion-adaptive interaction control, and multi-user aggregation, thereby enhancing the accuracy and robustness of intent determination, reducing redundant data processing, improving latency and resource utilization, and providing higher-level users with machine-generated organizational insights derived from coordinated artificial intelligence assistant functions.

The term “processor” refers to a hardware computation unit or a combination of hardware computation units, such as one or more central processing units or one or more specialized processing circuits, configured to execute instructions to perform information processing operations.

The term “terminal” refers to an information processing device operated by a user, such as a general-purpose computing device or a portable electronic device, configured to transmit input information to a server and to receive and present response information.

The term “user” refers to a human operator who interacts with the system through a terminal by providing natural language requests and receiving responses and notifications.

The term “higher-level user” refers to a user having a management or supervisory role who is authorized to access aggregated information relating to a plurality of users and to view organization-wide characteristic information.

The term “input information” refers to data received by the server from a terminal, including at least a natural language request provided by a user and optionally including metadata such as timestamps, device information, and session information.

The term “natural language request” refers to text information expressed in a human language, or speech information converted into text, which indicates an instruction, a question, or a request for assistance provided by a user to the system.

The term “user attribute information” refers to information associated with a user, including at least one of role, position, skills, preferences, historical interaction data, and access rights, which is used to personalize processing by the system.

The term “organization attribute information” refers to information associated with an organization to which a user belongs, including at least one of organizational structure, policies, procedures, work rules, and team configuration, which is used to contextualize processing by the system.

The term “prompt sentence” refers to text data constructed by the server and provided to a generative AI model, the text data including at least part of the input information and optionally including user attribute information, organization attribute information, and control instructions, and serving as a basis for the generative AI model to generate output.

The term “control information” refers to structured data generated by the server by integrating a prompt sentence with user attribute information and organization attribute information, and used as an input to a generative AI model for determining intent and processing type or for generating response information.

The term “generative AI model” refers to a trained machine learning model configured to generate output information, including at least one of natural language text and structured data, in response to input information such as a prompt sentence, by performing probabilistic computation over internal parameters.

The term “structured information” refers to machine-readable data output from the generative AI model, including at least intent information and processing type information, and represented in a structured format such as a key-value data structure or a hierarchical data structure.

The term “intent information” refers to information indicating a semantic purpose of a natural language request, such as schedule inquiry, notification setting, information search, work support, or job advice, determined by analysis of the input information.

The term “processing type information” refers to information indicating a category or type of processing to be executed by the server in response to a natural language request, such as schedule management processing, notification control processing, information retrieval processing, work support processing, or job advice processing.

The term “schedule management processing” refers to processing in which the server acquires or updates schedule information associated with a user, including at least retrieval, creation, modification, or deletion of event data in a scheduling resource.

The term “notification control processing” refers to processing in which the server configures, schedules, or triggers the transmission of notification information to a terminal, including at least the setting of reminder times, channels, and message contents.

The term “information retrieval processing” refers to processing in which the server acquires knowledge information or other data from one or more external information providing apparatuses or internal data sources in response to a user request.

The term “work support processing” refers to processing in which the server generates assistance related to work tasks of a user, including at least task prioritization, workflow suggestions, schedule optimization, and procedural guidance.

The term “job advice processing” refers to processing in which the server generates advice related to a user's job development, including at least career planning information, skill development recommendations, and training suggestions.

The term “external information providing apparatus” refers to a system distinct from the server and terminal, including at least one of a remote server, a cloud service, or a database system, which exposes an information acquisition interface for providing schedule information, communication information, or knowledge information.

The term “information acquisition interface” refers to a machine-readable interface, such as an application programming interface, through which the server can request and receive information from an external information providing apparatus.

The term “schedule information” refers to information relating to time-based events associated with a user, including at least event titles, times, dates, locations, participants, and related metadata.

The term “communication information” refers to information relating to messages or communications involving a user, including at least notification messages, reminders, and identifiers of communication channels.

The term “knowledge information” refers to information relating to facts, documents, articles, or other content obtained from external information providing apparatuses or internal data sources, which can be used to answer information retrieval requests or to generate advice.

The term “response data” refers to intermediate data representing the content of a response to be provided to a user, generated on the basis of acquired information and used to form a prompt sentence for a generative AI model.

The term “response information” refers to natural language text or other output generated by a generative AI model in response to a prompt sentence, and used as content to be presented to a user or used for further processing.

The term “display control information” refers to data specifying how response information or other information is to be presented on a terminal, including at least layout information, formatting information, and selection of elements to be displayed.

The term “notification control information” refers to data specifying how and when notifications are to be transmitted to and presented on a terminal, including at least timing information, priority information, and message content information.

The term “management information processing function” refers to a function executed by the server that aggregates and processes information relating to a plurality of users, and that generates work status index information and organization-wide characteristic information for use by a higher-level user.

The term “work status index information” refers to aggregated information representing states of work activities or interactions across a plurality of users, including at least indicators derived from input information, structured information, and response information.

The term “organization-wide characteristic information” refers to information representing characteristics of an organization derived from work status index information, including at least strength information and weakness information of the organization.

The term “emotion analysis processing apparatus” refers to a hardware and software configuration, which may be part of the server or externally connected to the server, configured to analyze input information to estimate emotion state information of a user.

The term “emotion analysis function” refers to a function that processes input information, including at least natural language text, to determine or estimate emotion state information such as stress level, satisfaction, or urgency.

The term “emotion state information” refers to information indicating an estimated emotional condition of a user, expressed in a machine-interpretable form such as a label, score, or vector.

The term “expression style” refers to stylistic attributes of response information, including at least politeness level, tone, degree of formality, length, and structure of the natural language text.

The term “individual artificial intelligence assistant function” refers to a logical assistant function or software component associated with a particular user, configured to process that user's input information, interact with the generative AI model, and manage user-specific context.

The term “work time period” refers to a time interval designated as a period in which work-related activities are normally performed by users in an organization.

The term “non-work time period” refers to a time interval designated as a period in which work-related activities are normally not performed by users in an organization.

The term “work support processing result information” refers to information representing outcomes of work support processing, including at least generated task plans, prioritization results, and schedule optimization results.

The term “job advice processing result information” refers to information representing outcomes of job advice processing, including at least recommended development plans, proposed learning paths, and suggested job actions.

The term “strength information” refers to organization-level information indicating advantageous or high-performing aspects of an organization, derived from aggregated work status index information.

The term “weakness information” refers to organization-level information indicating disadvantageous or low-performing aspects of an organization, derived from aggregated work status index information.

In one embodiment, a server, one or more terminals, and one or more users cooperate to implement the invention. The server includes at least one processor, a main memory, a non-volatile storage device, and a network interface. The server runs on a general-purpose computing platform such as a rack-mount computer or a virtual machine in a cloud environment executing an operating system such as a UNIX-compatible operating system. The server executes middleware and application software implemented, for example, in a runtime environment such as a Python interpreter or a Java virtual machine, and provides externally accessible functions through a web server and an application programming interface.

The terminal is an information processing device such as a smartphone, a tablet computer, or a personal computer including a display unit, an input unit, a microphone, a speaker, a wireless or wired communication unit, and a local processor. The terminal executes an application such as a native mobile application, a desktop application, or a web browser. The terminal provides a graphical user interface and an optional voice interface that allow the user to input natural language requests and to receive response information and notifications.

The user operates the terminal to input natural language text or speech representing a request. The terminal converts speech signals into text using a speech recognition module, which may be implemented by a local library or by a remote service, and transmits the text as part of input information to the server via a communication protocol such as Hypertext Transfer Protocol Secure.

The server stores, in the non-volatile storage device, a program composed of multiple software modules including at least an input management module, a user attribute management module, an organization attribute management module, a prompt generation module, a generative AI access module, a structured information interpretation module, a processing orchestration module, an external information interface module, a response generation module, a notification control module, a management aggregation module, and an emotion analysis interface module. The server also stores a data schema defining specific data structures such as user attribute records, organization attribute records, interaction logs, structured intent objects, work status index vectors, and organization-wide characteristic vectors.

The server uses a generative AI model as a core computational component. In one embodiment, the generative AI model is implemented as a transformer-based neural network including a plurality of encoder-decoder or decoder-only layers, each layer comprising multi-head self-attention units, feed-forward networks, layer normalization, and residual connections. The model is trained in advance on a large corpus of natural language documents using a self-supervised learning method that minimizes a loss function such as a cross-entropy loss between predicted tokens and actual tokens in the training data. During training, the server, or a training apparatus separate from the server, updates model parameters by backpropagation and stochastic gradient descent or a variant such as Adam. The training process applies techniques such as mini-batching, learning rate scheduling, weight decay regularization, dropout, and, optionally, data augmentation such as synonym replacement and paraphrase generation to improve generalization performance.

The server, at runtime, loads the generative AI model or accesses an external generative AI model service through the generative AI access module. The server converts a prompt sentence into a sequence of tokens using a tokenizer, maps the tokens to embedding vectors, and supplies the vectors to the generative AI model. The model computes context-dependent representations of the tokens by repeated application of the self-attention mechanism and the feed-forward networks, and outputs a probability distribution over tokens at each time step. The server decodes the output using a decoding strategy such as greedy decoding or beam search, thereby obtaining either natural language text or structured text, such as a structured representation in a machine-readable format. The server configures generation parameters such as temperature, top-k or top-p values, maximum output length, and presence or frequency penalties to control diversity and determinism.

The server uses explicit, machine-interpretable data structures to represent structured information. For example, the server defines an internal intent object containing fields such as an intent type, a date specification, a topic descriptor, and a processing priority. The server also defines a processing type object that indicates whether schedule management processing, notification control processing, information retrieval processing, work support processing, or job advice processing is to be executed. The server further defines a work status index vector as a multi-dimensional numerical vector whose elements include metrics such as request frequency per category, average processing latency, number of successful completions, and error frequencies across a plurality of users. The server defines organization-wide characteristic information as a higher-level representation derived from such vectors, for example, by applying dimension-reduction algorithms or clustering algorithms.

The server generates a prompt sentence for intent extraction and processing selection using the prompt generation module. The server retrieves user attribute information and organization attribute information from a relational database or key-value store and integrates these with the input information. The server then constructs a prompt sentence that includes explicit instructions and structured context, for example:

“You are an intent-classification assistant in an enterprise environment. Analyze the following user request and determine: (1) the main intent (choose one from: schedule management, notification setting, information search, work support, job advice), (2) all relevant parameters such as date, time range, topic, project name, and urgency level. Return the result strictly as a machine-readable list of key-value pairs. User role: software engineer. Organization policy: meetings should be limited in duration. User request: ‘Tell me all my meetings for tomorrow afternoon and set a reminder 30 minutes before each one.’” The server uses a generative AI model to output a structured description of the intent and processing type. By embedding precise instructions and user- and organization-specific context into the prompt sentence, the server reduces ambiguity and improves the accuracy of intent classification and parameter extraction compared to conventional rule-based or pattern-matching approaches. Because the model can interpret complex combinations of constraints and preferences, the server can avoid multiple clarification rounds, thereby reducing network round trips and server computation cycles.

The server then constructs a separate prompt sentence for generation of natural-language responses. For example, the server uses a prompt sentence such as:

“You are a personal work assistant for an employee in a large organization. Based on the following schedule data and user profile, generate a concise, user-friendly explanation of the user's meetings for tomorrow. Use the user's local time zone and include the time, location, and attendee summary. User role: software engineer. Meetings: [internal representation of meetings]. Please respond in polite and concise language suitable for a mobile user interface.”

By separating intent extraction and response generation into distinct prompt sentences with tailored instructions, the server can use a single generative AI model as a flexible computation engine that replaces multiple specialized parsers and generators. This architecture improves maintainability and allows the server to incorporate changes in processing logic by modifying prompt templates rather than by rewriting procedural code. The server uses the processing orchestration module to select processing flows based on the structured information output by the generative AI model. The server, for example, selects schedule management processing if the intent type indicates schedule-related operations. In this case, the server uses the external information interface module to call a calendar service via a defined information acquisition interface. The server constructs query parameters based on the date and time range extracted from the natural language request, performs time zone conversions using a date-time library, and sends a request to the external calendar service. The external service returns schedule information as machine-readable data, which the server converts into an internal event structure. The server aggregates events, eliminates duplicates, and orders the events in chronological order, thereby producing a compact dataset suitable for input to the generative AI model.

The server can also perform information retrieval processing by calling an external knowledge service or document repository. The server, in this embodiment, computes feature vectors for user queries and candidate documents using an embedding model and applies similarity search algorithms in a vector space. By doing so, the server retrieves knowledge information that is semantically close to the user's query, even when exact keyword matches are not present. The server then passes summaries or excerpts of retrieved documents to the generative AI model as part of a prompt sentence for answer generation.

The server uses an emotion analysis processing apparatus to estimate emotion state information. In one embodiment, the emotion analysis processing apparatus includes a neural network trained on labeled emotion datasets, where the input consists of text embeddings of user utterances and the output consists of emotion categories or continuous scores such as valence and arousal. The training process minimizes a classification or regression loss and updates network weights through backpropagation. The server, at runtime, converts the user's input information into embeddings, feeds them to the emotion analysis model, and receives emotion state information such as “high stress,” “uncertain,” or “calm.” The server uses this information to adjust generation parameters of the generative AI model, for example, by reducing temperature for stressed users to produce more direct and unambiguous responses, or by increasing explanatory detail for uncertain users. The server also uses the emotion state information to control notification timing, such as delaying non-urgent notifications when the emotion state indicates overload.

The server configures display control information and notification control information in a way that is optimized for the terminal and the network environment. For example, the server selects a compact representation of responses that reduces payload size and minimizes bandwidth consumption over wireless connections, while preserving the semantic content of the response. The server may generate structured display hints such as which portions of text should be highlighted, grouped into collapsible sections, or converted into interactive elements. This representation allows the terminal to render the interface efficiently using local resources without requiring repeated queries to the server for layout information.

The server, through the management aggregation module, processes interaction logs from a plurality of users to compute work status index information and organization-wide characteristic information. The server maintains data structures in a time-series database or analytical database, where each entry encodes user ID, timestamp, intent category, processing latency, success or failure flags, and other attributes. The server applies aggregation operations over these data, such as summation, averaging, and weighted averaging over sliding windows, to produce index values for each user and for each team. The server then applies analysis techniques such as clustering, principal component analysis, or anomaly detection to identify patterns representing organizational strengths and weaknesses. For example, if the server detects an unusually high volume of schedule conflicts across a particular team, it can identify this as weakness information associated with scheduling practices. The server then generates organization-wide characteristic information that a higher-level user can view via a management terminal.

The server further controls inter-assistant communication among multiple individual artificial intelligence assistant functions. Each function maintains local context for a given user. The server, in one embodiment, uses a coordination module that periodically or conditionally exchanges selected elements of schedule information, work support processing result information, and job advice processing result information between assistants under access control and privacy policies. The server, for example, may compute a shared team focus time window by intersecting the availability blocks from multiple user schedules, and then use this shared information to adjust individual users' meeting suggestions. This inter-assistant coordination, governed by algorithmic rules that consider team-level optimization rather than only user-level priorities, provides an improvement over conventional systems that treat each assistant as an isolated process.

The server benefits from these structures and algorithms in several technical ways. By representing intent and processing type as structured information derived from a generative AI model, the server reduces the complexity of hand-crafted parsers and related branching logic. This reduction in complexity leads to fewer branches in server code paths and more predictable execution, which decreases processing time variance and improves overall latency. By embedding user and organization attributes directly into the prompt sentence, the server reduces the need for server-side iterative refinement, since the generative AI model can evaluate context-rich instructions in a single inference. This leads to fewer network transmissions and lower use of computational resources.

The server also improves accuracy and robustness because the generative AI model, when guided by carefully designed prompt sentences, can handle ambiguous or incomplete user input more effectively than conventional pattern-based systems. The server adapts temperature and decoding strategies in response to emotion state information, which further stabilizes outputs and reduces the likelihood of generating inappropriate or confusing content, thereby decreasing the number of error recovery operations.

The server improves data management by defining explicit data structures for work status indices and organization-wide characteristics, and by applying analytical algorithms to these data structures. This provides a technical mechanism for transforming raw interaction logs into compact, high-level vectors usable for computational decision-making, without requiring human interpretation at each stage. The server thus uses computer resources to derive organizational insights automatically and to feed those insights back into the behavior of individual assistants, achieving a closed-loop optimization system.

The server employs non-conventional processing sequences that differ from simple automation of human workflows. For example, the server uses a dual-prompt strategy in which the same generative AI model performs both intent extraction and response generation, but under different instruction regimes and with different context integration rules. The server also uses emotion-adaptive parameter control for the model, which is not a direct imitation of human decision-making but a computational strategy to improve numerical stability and user-perceived quality. Furthermore, the server coordinates multiple independent assistant contexts through algorithmic aggregation and synchronization procedures that have no direct analog in human team management.

In alternative embodiments, the server can employ a different type of generative AI model, such as a recurrent neural network with attention, a convolutional network with autoregressive decoding, or a hybrid model that combines symbolic reasoning modules with neural language models. The server can also divide model functions between a local model deployed on the terminal and a remote model deployed on the server, thereby reducing network traffic and improving responsiveness for certain tasks. The server may compress model parameters using quantization or pruning techniques to adapt to environments with limited computing resources.

In another variation, the server can use different emotion analysis methods, such as lexicon-based sentiment analysis combined with machine learning classifiers or multimodal models that consider both textual and acoustic features. The server can also vary the algorithms for computing work status index information and organization-wide characteristics, for example by employing graph-based methods that represent users and tasks as nodes in a graph and edges as relationships such as dependencies or communication links. The terminal, in all of these embodiments, acts as both an input capture device and an output presentation device. The terminal executes a local application that parses display control information and notification control information. The terminal renders user interfaces based on layout directives from the server, manages local caches of recent responses, and triggers local notifications through the operating system notification framework according to timing specified by the server. By offloading complex semantic processing to the server and limiting local processing to presentation logic and simple interaction handling, the terminal conserves battery power and reduces the need for high-performance local hardware.

The user interacts with the system by issuing natural language requests and by reviewing and acting on responses. The user can, for example, ask:

“Optimize my meetings next week so that I have at least three hours of uninterrupted focus time each day.”

The server, by analyzing this request through the described generative AI and orchestration architecture, can determine a non-trivial optimization strategy over the user's schedule that considers multiple days, time zones, and organizational constraints. This is not a mere automation of a human scheduling task, but a computation-intensive optimization that relies on internal data structures and algorithms that are well suited to machine processing.

By implementing these embodiments, the server, the terminal, and the user form a system that uses generative AI models and structured prompt sentences in a concrete, technically grounded way that improves computer performance, reduces communication overhead, and enhances the reliability and usefulness of the overall system.

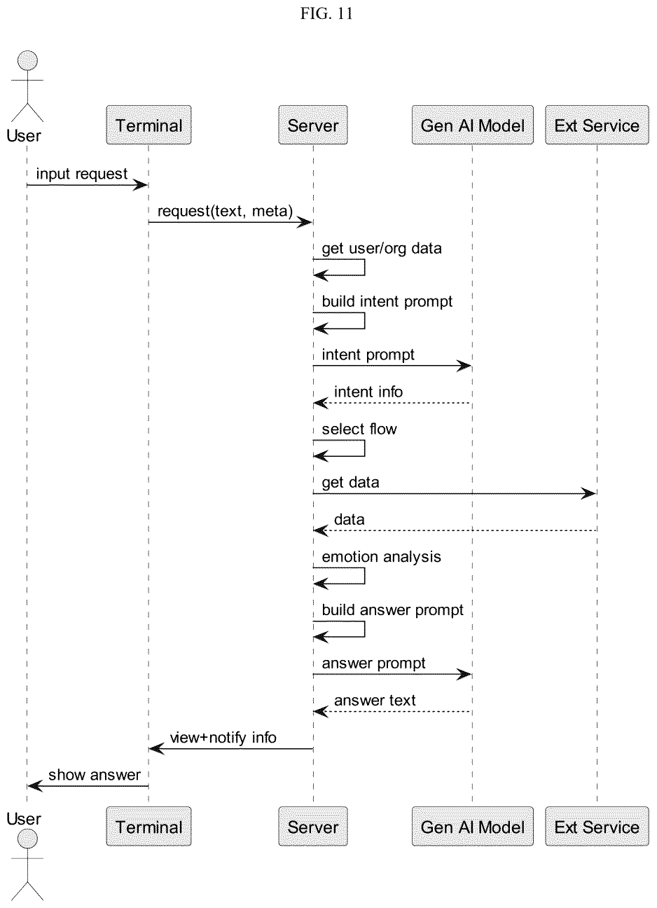

The following describes the processing flow using FIG. 11.

### Step 1:

The user operates the terminal to input a natural language request. The user provides input as text typed into a text field or as speech captured by a microphone. The terminal receives, as input, raw user input data (text string or audio waveform). The terminal, when receiving audio, performs a data conversion operation in which the terminal applies a speech recognition algorithm to the audio waveform, segments the waveform into frames, extracts acoustic features, and maps them to characters or words to obtain a text string. The terminal outputs normalized request text together with metadata such as a timestamp, a terminal identifier, and a user identifier.

### Step 2:

The terminal constructs a request payload for the server. The terminal uses, as input, the normalized request text and local metadata (terminal type, language settings, session ID). The terminal performs a data structuring operation in which it maps these values into a structured object, for example assigning keys such as “userId”, “text”, “time”, and “deviceType” to corresponding values. The terminal outputs a structured payload and transmits this payload to the server via a secure communication protocol, thereby outputting an HTTP request containing the structured payload as its body.

### Step 3:

The server receives and authenticates the request. The server uses, as input, the HTTP request containing the structured payload. The server performs a first data parsing operation, in which it parses HTTP headers and body, extracts the structured payload, and validates an authentication token or session identifier by comparing it against records in an authentication store. The server also performs a logging operation, storing user ID, timestamp, and raw request text into a log store. The server outputs a validated request object containing the user identifier, the request text, and the associated metadata.

### Step 4:

The server retrieves user attribute information and organization attribute information. The server uses, as input, the validated request object including the user identifier. The server performs a database query operation against a user attribute store and an organization attribute store. The server, for example, executes key-based lookups or relational queries to obtain records such as role, department, skills, notification preferences, and organization policies. The server merges the retrieved fields into a unified context object. The server outputs a context object that includes user attribute information, organization attribute information, and the original request text.

### Step 5:

The server constructs an intent-extraction prompt sentence. The server uses, as input, the context object including the request text, the user attributes, and the organization attributes. The server performs a text assembly operation in which it concatenates fixed instruction segments with variable segments. The server inserts values such as the user role and policy excerpts into predefined template positions and appends the exact request text. The server may also attach delimiters or markers to separate instruction parts from request parts. The server outputs a prompt sentence such as:

“You are an intent-classification assistant in an enterprise environment. Analyze the following user request and determine: the main intent (choose one from: schedule management, notification setting, information search, work support, job advice), and all relevant parameters such as date, time range, topic, project name, and urgency level. Return the result strictly as a list of key-value pairs. User role: software engineer. Organization policy: meetings should be limited in duration. User request: ‘Tell me all my meetings for tomorrow afternoon and set a reminder 30 minutes before each one.’”

### Step 6:

The server invokes the generative AI model for intent extraction. The server uses, as input, the intent-extraction prompt sentence. The server performs a tokenization operation, converting the prompt sentence into discrete tokens, and maps each token to an embedding vector using an embedding table. The server then forwards the sequence of embeddings to a transformer-based generative AI model. Inside the model, multiple layers execute self-attention and feed-forward operations that compute contextualized representations. The server configures decoding parameters such as temperature and maximum token count and obtains an output token sequence representing structured text (e.g., key-value style data). The server then applies a detokenization operation to convert output tokens back into a text string. The server outputs structured information in textual form that encodes intent information and processing type information.

### Step 7:

The server interprets the structured information into machine-readable objects. The server uses, as input, the structured textual information from the generative AI model. The server performs a parsing operation, in which it scans the text for known labels such as “intent:”, “date:”, “time_range:”, and “processing_type:”, and extracts the associated values. The server then maps these values into an internal intent object and processing type object. The server may normalize dates into a canonical date-time format and convert string labels into enumerated values. The server outputs an intent object and a processing type object that precisely specify the requested operation (for example, intent: schedule management, date: specific day, reminder: 30 minutes before).

### Step 8:

The server selects an appropriate processing flow. The server uses, as input, the intent object and the processing type object. The server performs a branching operation using conditional logic: for each processing type value, the server associates a different handler module. For example, if the processing type indicates schedule management, the server selects a schedule handler; if it indicates information search, the server selects an information retrieval handler. The server also computes a processing priority value, for example using a rule that combines urgency level, user role, and type of operation. The server outputs a processing selection result specifying which handler module shall execute and with what priority.

### Step 9:

The server acquires external schedule information when schedule management is selected.

The server uses, as input, the processing selection result and the intent object including date and time range. The server performs an external interface operation: it constructs an API query by encoding the user's calendar identifier, the target time interval, and filters into URL parameters or request body fields. The server sends this query via a communication protocol to an external scheduling service. The external service returns schedule information as structured event data. The server executes a data transformation operation, converting event times into the user's local time zone and mapping external field names (such as “start”, “end”, “summary”) into internal field names. The server outputs a list of normalized schedule events for the specified period.

### Step 10:

The server acquires external knowledge information when information retrieval is selected.

The server uses, as input, the processing selection result and the intent object including a topic description. The server performs a query formulation operation, in which it selects important keywords or constructs a natural language query string. The server sends the query to a knowledge repository or search system via a defined information acquisition interface. The search system returns a ranked list of documents or snippets. The server executes a selection operation to choose a subset of top-ranked items and applies a shortening algorithm to limit text length. The server outputs a set of knowledge snippets and associated metadata such as titles and source identifiers.

### Step 11:

The server computes emotion state information. The server uses, as input, the original request text and, optionally, prior interaction text segments. The server converts the text into feature vectors using a text embedding model, then forwards the vectors to an emotion analysis processing apparatus. Inside that apparatus, a neural network executes matrix multiplications and non-linear activation functions to calculate scores for emotion classes or continuous dimensions. The server receives these scores and performs a selection or thresholding operation to determine a discrete emotion label or a simplified set of scores. The server outputs emotion state information such as “high stress” or “neutral.”

### Step 12:

The server prepares response data for answer generation. The server uses, as input, the normalized schedule events, the knowledge snippets, the user attribute information, and the emotion state information. The server performs a data aggregation operation: it combines schedule events into a single structure or groups them by day and computes derived values such as number of meetings per day. For knowledge snippets, the server may compute similarity scores between snippets to remove near-duplicates. The server then constructs a response data object that includes structured content, such as a list of events or a list of summarized knowledge items, as well as context such as user role and preferred detail level. The server outputs a consolidated response data object to be used for prompt generation.

### Step 13:

The server constructs a response-generation prompt sentence. The server uses, as input, the consolidated response data object and the emotion state information. The server performs a template expansion operation, in which it selects a base response template appropriate for the detected intent and emotion: for example, a concise template for stressed users, and a more detailed template for neutral users. The server fills in placeholders in the template with schedule event descriptions or knowledge snippet contents. The server then appends explicit instructions about style and structure, such as “Respond concisely and clearly suitable for display on a mobile device.” The server outputs a response-generation prompt sentence such as:

“You are a personal work assistant for an employee. Based on the following schedule data, explain the user's meetings for tomorrow afternoon clearly and concisely. Use the user's local time zone and a calm, reassuring tone. Meetings: [internal event descriptions].”

### Step 14:

The server invokes the generative AI model for response generation. The server uses, as input, the response-generation prompt sentence. The server performs tokenization and embedding as in Step 6, then executes the generative AI model layers to compute context-aware representations. The server sets decoding parameters based on emotion state information, for example lowering temperature for higher determinism when the emotion state indicates stress. The server generates output tokens step by step until an end-of-sequence condition is met, then detokenizes them into text. The server outputs response information in natural language, such as “You have two meetings tomorrow afternoon: one from 1:00 PM to 2:00 PM in Conference Room B with the development team, and another from 3:30 PM to 4:00 PM as an online call with the design team.”

### Step 15:

The server generates display control information and notification control information. The server uses, as input, the response information and, when applicable, schedule event times and reminder parameters from the intent object. The server performs a layout mapping operation in which it analyzes the length and structure of the response text and assigns display attributes such as header sections, bullet lists, and emphasis markers. For notifications, the server computes reminder timestamps by subtracting the requested lead time (for example, 30 minutes) from event start times and encodes these times along with notification messages into a notification configuration. The server outputs display control information for immediate rendering on the terminal and notification control information for future delivery.

### Step 16:

The server updates management aggregation data. The server uses, as input, the intent object, the processing type object, the processing latency measurements, any error codes, and outcome indicators (such as success in retrieving schedule information). The server performs an aggregation update operation: it maps these values into per-user and per-team counters and averages stored in a data store, incrementing counts, updating running means, and recalculating derived metrics such as rate of schedule conflicts or average number of information requests. The server also updates work status index vectors by writing new metric values into specific dimensions. The server outputs updated work status index information and stores it for later calculation of organization-wide characteristic information.

### Step 17:

The terminal receives and renders the response. The terminal uses, as input, the display control information and the response information transmitted from the server. The terminal performs a decoding operation on the structured display control information and maps it to user interface components, such as text views, list items, and notification banners. The terminal applies font sizes, colors, and layout parameters according to the control information. The terminal renders the response text on the display and, if required, schedules local notifications using the operating system's notification framework based on the notification control information. The terminal outputs visual and, optionally, audible output that the user can perceive.

### Step 18:

The user reviews the response and optionally issues a follow-up request. The user uses, as input, the displayed information and any notifications received on the terminal. The user evaluates whether additional assistance is needed and may compose a new natural language request, for example “Can you move less important meetings to next week?” The terminal, upon receiving the new request, repeats the operations from Step 1, generating a new input for the server. The system thus performs iterative cycles of data acquisition, AI-based interpretation, targeted processing, and adaptive response generation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for supporting business operations, such as factory scheduling tools or inventory management tools, typically treat schedule information, inventory information, and user interaction history as separate data streams processed by distinct software modules. In such systems, a processor generally executes predefined rules or static optimization algorithms without leveraging a generative AI model that can flexibly interpret complex context described in natural language. As a result, these systems often cannot adaptively generate personalized advice for individual users in response to rapidly changing operation conditions, and cannot continuously improve their recommendation quality based on user feedback.

Furthermore, in many existing architectures, the processor does not generate structured prompt sentences tailored to a generative AI model. Instead, either human operators must manually compose ad hoc instructions for the model, or the model is invoked with generic, context-poor inputs. This leads to inefficient use of computing resources, increased latency due to additional human input, and unstable or inconsistent outputs from the model. The absence of a systematic prompt generation mechanism at the processor layer makes it difficult to reliably integrate generative AI into mission-critical operation flows. In addition, conventional systems typically lack a closed feedback loop in which response information from users and actual operation result information are automatically collected, normalized, and reused as learning data to retrain or fine-tune the generative AI model. Without such a loop, the model remains static or is updated only through costly, manual retraining cycles. This causes deterioration of recommendation relevance over time as business conditions, operation patterns, and user behavior evolve. The processor therefore fails to improve its internal models in a data-driven manner, leading to suboptimal computer performance in decision-support tasks.

From an organizational perspective, known systems also tend to provide fragmented views to managers. Even when dashboards aggregate some schedule and inventory metrics, the aggregation logic is usually hard-coded and not directly aligned with the behavior of the artificial intelligence assistants that interact with individual users. The processor is not configured to aggregate operation schedule information, inventory information, user response information, and operation result information in a unified representation that both reflects the underlying AI-driven interactions and exposes organization-wide strengths and weaknesses. As a consequence, higher-level users must manually correlate multiple reports and interfaces, producing additional cognitive load and increasing the risk of misinterpretation. Furthermore, existing computer systems that provide artificial intelligence assistants often focus on user-facing conversational features without optimizing the internal technical handling of context sharing among multiple assistants. In many architectures, separate instances of assistants for different users do not systematically exchange structured operation schedule information, inventory information, and advice information at the processor level. This siloed design prevents the system from computationally identifying cross-user patterns, such as global bottlenecks or systemic resource imbalances, and therefore limits the processor's ability to compute organization-level evaluation information. The result is an underutilization of the computing infrastructure and a failure to extract higher-order insights from the distributed interactions between assistants and users.

Accordingly, there is a need for an improved computer-implemented system in which a processor: (i) automatically acquires and organizes operation schedule information and inventory information per user; (ii) generates and supplies structured prompt sentences to a generative AI model so that context-rich, machine-parseable advice is produced; (iii) closes the loop by capturing user response information and operation result information and using them to update learning data and refine the model; and (iv) aggregates multi-user and multi-assistant information to compute organization-level management and evaluation information. Such a configuration would improve the functioning of the computer system itself by enabling more efficient use of model inference resources, reducing redundant human intervention, improving prediction and recommendation accuracy over time, and providing more coherent and machine-generated aggregate views to higher-level users.

The specific processing by the specific processing unit 290 of the data processing device 12 in Application Example 1 is realized by the following means.

The present invention provides a server comprising a processor configured to provide, for each of a plurality of users, a personalized artificial intelligence assistant and acquire and organize operation schedule information and inventory information for each user; to generate a prompt sentence to be input to a generative AI model based on the operation schedule information and the inventory information, to input the prompt sentence to the generative AI model, and to generate advice information for improving work efficiency; to distribute the advice information as notification information to user terminals and to acquire response information from the users to the notification information and operation result information; to update learning data of the generative AI model using the acquired response information and the operation result information and to retrain or fine-tune the generative AI model to improve accuracy of generation of the advice information; to aggregate the acquired operation schedule information, the inventory information, the response information, and the operation result information, and to generate aggregate information that indicates an overview of an entire organization's operation status and resource utilization status for a manager; to generate and provide management information based on the aggregate information, the management information enabling a higher-level user to grasp, via the personalized artificial intelligence assistants corresponding to lower-level users, progress statuses of operations and inventory statuses of the lower-level users in an overview manner; and to mutually link operation schedule information, inventory information, and advice information among the personalized artificial intelligence assistants corresponding to the plurality of users, generate evaluation information indicating strengths and weaknesses of an organization based on a result of the linking, and provide the evaluation information to the higher-level user. This enables the computer system to technically improve its internal operation by automatically constructing structured prompt sentences for the generative AI model, efficiently orchestrating data flows among schedule, inventory, and feedback data, continuously adapting the model parameters based on real-world interaction outcomes, and programmatically generating coherent aggregate and evaluation information, thereby enhancing the precision, responsiveness, and scalability of AI-driven decision support while reducing manual intervention and processing inefficiencies.

The term “system” refers to a combination of one or more computing devices including at least one processor and associated memory, communication interfaces, and storage, configured to execute instructions to perform the functions described in the claims.

The term “processor” refers to a hardware processing unit, such as a central processing unit or a processing core thereof, or a combination of such units, that executes machine-readable instructions to carry out data processing operations described in the claims.

The term “user” refers to an operator, worker, manager, or other human individual who interacts, directly or indirectly, with the system and for whom operation schedule information, inventory information, and advice information are handled.

The term “personalized artificial intelligence assistant” refers to a software-based agent executed by the processor, configured with parameters, profiles, or models specific to a particular user, and adapted to provide advice, notifications, and other support functions tailored to that user.

The term “operation schedule information” refers to data indicating planned or actual tasks, jobs, activities, or operations associated with one or more users, including at least one of task identifiers, time periods, priorities, and resource assignments.

The term “inventory information” refers to data indicating availability, quantity, status, or allocation of physical or logical resources, including at least one of parts, materials, products, or other items used or produced in an operation.

The term “generative AI model” refers to a machine-learned computational model, such as a neural network, that is configured to generate data, including natural-language text, based on input data or prompt sentences.

The term “prompt sentence” refers to a structured natural-language or machine-readable text generated by the processor and supplied as input to the generative AI model to condition or guide the generation of output from the generative AI model.

The term “advice information” refers to data generated by the generative AI model or by processing results thereof, including recommendations, suggested task sequences, alerts, or instructions intended to improve work efficiency or support decision making.

The term “notification information” refers to message data derived from advice information and formatted for presentation on a user terminal, including at least one of a title, body text, priority indicator, and action option.

The term “user terminal” refers to an endpoint computing device operated by or associated with a user, such as a desktop device, portable device, or wearable device, that is configured to receive, display, and transmit information to and from the system.

The term “response information” refers to data indicating a user's reaction or input with respect to notification information or advice information, including at least one of acceptance, rejection, modification, comments, or other user feedback.

The term “operation result information” refers to data representing outcomes of executed tasks or operations, including at least one of start times, end times, completion statuses, delays, throughput, or resource usage.

The term “learning data” refers to data sets or records used to train, retrain, or fine-tune the generative AI model, including at least one of prompt sentences, advice information, response information, and operation result information.

The term “retrain or fine-tune” refers to a process in which the processor executes additional training steps on the generative AI model using learning data, to update internal parameters of the model and adjust its output behavior.

The term “aggregate information” refers to data produced by combining, summarizing, or statistically processing operation schedule information, inventory information, response information, and operation result information across a plurality of users or operations.

The term “operation status” refers to an overall or partial state of ongoing or completed tasks or operations within an organization, including metrics such as progress, delay, completion rate, and workload distribution.

The term “resource utilization status” refers to an overall or partial state of usage of resources, including at least one of machines, personnel, materials, or time, and may include indicators such as utilization rate, idle time, or shortage levels.

The term “manager” refers to a user in a supervisory or administrative role who is authorized to view aggregate information, management information, or evaluation information regarding multiple users or operations.

The term “management information” refers to data derived from aggregate information and formatted or structured to enable a higher-level user to monitor, evaluate, or control operations and resources associated with lower-level users.

The term “higher-level user” refers to a user in a relatively senior or supervisory position in an organizational hierarchy, who receives management information or evaluation information concerning multiple other users.

The term “lower-level user” refers to a user in a relatively subordinate or operational position in an organizational hierarchy, whose operation schedule information, inventory information, response information, and operation result information are managed or observed via the system.

The term “link” or “linking” refers to a process in which the processor associates, correlates, or integrates multiple items of data, such as operation schedule information, inventory information, and advice information, across different users or assistants.

The term “evaluation information” refers to data computed by the processor that characterizes performance, behavior, or characteristics of an organization, including at least one of strengths, weaknesses, bottlenecks, or improvement opportunities.

The term “organization” refers to a group of users, resources, and operations that are managed in a coordinated manner, such as a division, department, production line, or enterprise unit.

In one embodiment, a server implements the claimed system as a computer system including at least one processor, a main memory, a non-volatile storage device, and a network interface. The server executes an operating system such as a general-purpose server operating system and executes application software implemented, for example, using a programming language and standard libraries. The server cooperates with one or more terminals operated by users. Each terminal may be realized as a portable computing device, a stationary computing device, or an industrial control device, and includes a display, an input interface, and a communication interface.

Server stores, in the non-volatile storage device, a plurality of software modules including: a schedule management module, an inventory management module, a prompt generation module, a generative AI interface module, an advice post-processing module, a feedback collection module, an aggregation and analytics module, and a model training module. Server also stores, in the storage device, one or more generative AI models, such as sequence-to-sequence neural network models or transformer-based neural network models, implemented using a machine learning framework. Server further stores structured data in one or more databases, such as relational tables that maintain operation schedule information, inventory information, response information, and operation result information.

Server provides, for each user, a personalized artificial intelligence assistant. Server realizes the assistant as a logical software instance associated with user-specific data structures stored in the database. These data structures may include a user profile record, a historical schedule record, a historical advice record, and an interaction history record. Server maintains such records in normalized relational tables; for example, server stores operation schedule information with a schema including fields corresponding to user identifier, task identifier, resource identifier, planned start time, planned end time, task priority, and status flags. Server stores inventory information with a schema including fields corresponding to item identifier, current stock quantity, reserved quantity, safety stock threshold, and forecasted consumption. Server uses specific software libraries to process these data structures efficiently. For example, server uses a data analysis library to load schedule and inventory records into in-memory table-like structures that support indexed access, grouping, and aggregation. Server uses a numerical computation library to represent numeric vectors of quantities, time intervals, and feature values as arrays and matrices, and performs arithmetic operations such as element-wise addition, subtraction, comparison, and normalization. By using these libraries, server reduces the processing time for large data sets, improves cache locality, and minimizes overhead associated with manual data parsing.

Server constructs a personalized context for each user by combining operation schedule information, inventory information, and user-specific historical information. Server uses join operations on the in-memory table structures to associate each scheduled task with a set of required inventory items, and to attach to each task a vector of features including at least: remaining time until scheduled start, estimated processing duration, current inventory surplus or deficit for each required item, historical delay statistics for similar tasks, and user-specific performance measures. Server normalizes these features, for example by scaling numerical values into a fixed range or applying z-score normalization, in order to provide stable input distributions to downstream neural network components.

Server generates a prompt sentence for a generative AI model by transforming the structured context into a natural-language representation with embedded, machine-parsable structure. Server uses a prompt generation module that formats the context according to predetermined templates. For example, server may generate a prompt sentence of the following type: “Generative AI model, based on the following context: User U001 is scheduled for Task T1005 on Resource R10 from 09:00 to 10:30. Required items are Item A (current stock 15 units, required 20 units) and Item B (current stock 50 units, required 10 units). Recent operations for User U001 have experienced an average delay of 10 minutes for similar tasks. Please propose the next optimal work sequence and concrete advice to avoid delays, including whether to reorder tasks or trigger replenishment.”

Server may also generate a more generic prompt sentence that can be reused across users, such as:

“Generative AI model, based on the current work schedule and inventory status for user U001 during the next 4 hours, propose the next optimal work sequence and specify any required replenishment actions.”

Server constructs these prompt sentences automatically from the structured context by inserting specific numeric values, identifiers, and summary statistics into predefined text patterns. This approach differs from simple human-authored prompts because server systematically encodes relevant features while excluding irrelevant noise, thereby reducing the dimensionality of the effective input space and improving inference stability. Server inputs the prompt sentence to the generative AI model using the generative AI interface module. In one embodiment, the generative AI model is a transformer-based neural network including an embedding layer, a plurality of self-attention layers, feedforward layers, and an output projection layer. Server uses a tokenizer to transform the prompt sentence into a sequence of token identifiers, and then maps each token identifier to a dense vector using the embedding layer. Server feeds the resulting tensor into the self-attention layers. Each self-attention layer computes attention scores by performing matrix multiplication between query and key matrices derived from the input representations, applies a softmax function to obtain normalized attention weights, and then multiplies the values by the attention weights to produce updated representations. Feedforward layers then apply linear transformations and non-linear activation functions to these representations.

Server configures the generative AI model with parameters such as the number of layers, the number of attention heads, the hidden dimension size, and the vocabulary size. Server stores these parameters as part of the model configuration. During inference, server controls decoding behavior using techniques such as beam search or top-k sampling, limiting maximum sequence length and controlling randomness by adjusting a temperature parameter or similar controls. By constraining and parameterizing the decoding procedure, server reduces unnecessary computation, prevents excessively long outputs, and improves the consistency of the generated advice.

Server receives as output from the generative AI model a sequence of token identifiers representing advice information. Server converts these token identifiers back into a text string using the tokenizer's vocabulary mapping. Server then executes the advice post-processing module to extract structured elements from the generated text. For example, server may parse the generated text to detect tokens corresponding to task identifiers, time offsets, item identifiers, and action verbs (such as “postpone,” “advance,” “replenish,” or “reassign”). Server may use rule-based pattern matching, regular expressions, or a lightweight auxiliary classifier to identify and validate these elements. By enforcing internal consistency checks-such as ensuring that referenced tasks and items exist in the database and that suggested time windows do not overlap with immovable tasks-server avoids propagation of unusable advice to terminals.

Server converts the validated advice information into notification information formatted for each user terminal. Server may create notification records including a title indicating the type of advice (for example, “Schedule adjustment recommended”), a body summarizing the key recommendation (for example, “Postpone Task T1005 by 30 minutes and start Task T1006 on Resource R11 now. Replenish 50 units of Item A.”), and optional metadata indicating priority and associated actions. Server transmits this notification information through a communication protocol such as a push-notification service or a message broker. Server also records the transmission event in a log table, including timestamps and identifiers, enabling later analysis of latency and delivery success rates.

Terminal receives the notification information through its communication interface. Terminal executes a client application that registers with the notification service and listens for incoming messages. Terminal parses the notification payload and displays the title and body on the display device. Terminal may present buttons or interactive controls allowing user to accept a suggested plan, reject it, or request more details. Terminal may also provide a detailed view showing a task list, a timeline, and inventory levels, based on data fetched from server. This structured display reduces cognitive load for user and ensures that decision making is guided by machine-prepared context.

User examines the notification and interacts with terminal. When user accepts the advice, user selects an “Accept” control, and terminal sends response information back to server, including an indication of acceptance, the timestamp of acceptance, and any comments provided by user. When user rejects advice, terminal similarly sends response information indicating rejection and, optionally, a free-text explanation. Terminal also sends operation result information as tasks are started and completed. For example, terminal may automatically or semi-automatically send a message when Task T1006 is started and another when it is completed, including actual start and end times and any recorded disruptions. Server receives response information and operation result information via an application programming interface. Server writes this information into dedicated tables that link each piece of feedback to the originating advice, prompt sentence, and context. Server may transform these feedback and result records into numerical feature vectors describing, for each advice instance, whether it was accepted, whether it led to a reduction in delay, whether resource utilization improved, and similar metrics. Server stores these derived features as part of the learning data used by the model training module.

Server executes the model training module periodically or based on a trigger condition, such as accumulation of a threshold number of new feedback records. Server constructs a training dataset by pairing prompt sentences (or compact representations of context) with target output sequences that reflect desirable advice behavior, for example, advice that was accepted by users and that led to improved operation result information. Server may represent the targets as edited or normalized variants of historical advice text. Server then uses a learning algorithm, such as stochastic gradient descent or a variant thereof, to update the parameters of the generative AI model.

Server computes a loss function that measures the discrepancy between the model's generated outputs and the target sequences. In one embodiment, server uses a token-level cross-entropy loss, possibly weighted to emphasize correctness of critical entities such as task identifiers and item identifiers. Server calculates gradients of the loss with respect to model parameters using automatic differentiation provided by the machine learning framework, and updates the parameters using an optimizer such as an adaptive gradient-based optimizer. Server repeats this process over mini-batches of training data, updating weights iteratively. By defining the loss function and optimization procedure in this way, server explicitly adjusts the internal probability distributions of the generative AI model to favor advice patterns that users have historically accepted and that improved real-world outcomes.

Server controls the model training process with hyperparameters such as batch size, learning rate, and number of training epochs. Server may also use data augmentation techniques on the prompt sentences, such as paraphrasing or shuffling non-critical segments of context, to improve robustness to slight variations in input wording. Server may split data into training and validation subsets; server evaluates model performance on validation data to detect overfitting and to decide when to stop training or when to roll back a model update. Server may maintain versioned models and gradually deploy updated models while monitoring metrics such as acceptance rate, average delay, and computation time.

Server aggregates operation schedule information, inventory information, response information, and operation result information across multiple users using the aggregation and analytics module. Server performs grouping and aggregation operations on the in-memory tables to compute metrics such as average delay per resource, number of replenishment events per item, and utilization distributions across shifts. Server then generates aggregate information that characterizes the operation status and resource utilization status of the entire organization. Server stores this aggregate information in dedicated tables and makes it accessible to manager accounts through a management interface.

Server also computes evaluation information indicating strengths and weaknesses of the organization. For example, server may compute rankings of resources or items by frequency of bottlenecks, identify patterns where certain tasks systematically cause delays, or detect that certain users receive a higher proportion of rejected advice. Server may apply clustering algorithms or dimensionality reduction techniques to feature vectors representing tasks, resources, and advice, in order to identify latent structures such as typical failure modes or highly efficient patterns. Server uses these computed results to generate textual explanations for managers, such as “Operations involving Resource R10 show consistently high delay due to recurrent shortages of Item A,” or “Advice for tasks of type X is frequently rejected, indicating misalignment of model assumptions.” These explanations are generated using deterministic templates or by constrained calls to the generative AI model under strict token budgets and with domain-specific constraints.

Server thereby provides managers with a coherent, machine-derived view that correlates AI-driven advice, human responses, and physical inventory behavior. This reduces the need for manual cross-referencing of disparate reports and enables technical improvements, such as early detection of systemic bottlenecks and better configuration of safety stock thresholds. From a technical standpoint, the described configuration improves computer technology in several ways. Server uses structured prompt generation and context encoding to reduce noise in generative AI inputs, which leads to more stable and concise outputs, reducing downstream parsing complexity and CPU usage. Server implements a closed feedback loop in which response information and operation result information are automatically transformed into learning data, enabling continual adaptation of the model without manual dataset curation. This adaptive process results in lower error rates in recommended schedules, reduced need for manual overrides, and improved processing efficiency because the model more accurately predicts feasible actions over time. Server distributes computation across specialized modules and uses optimized data structures for schedule and inventory representation, which reduces memory overhead and improves cache utilization relative to naïve, unstructured data handling.

Moreover, server executes algorithmic processes that are not mere automation of human mental steps. For instance, server performs high-dimensional feature calculations, matrix multiplications, and gradient-based optimization that humans cannot perform manually at comparable speed or scale. Server leverages non-obvious rules and internal representations learned by the neural network that capture complex, non-linear relationships between schedule timing, inventory dynamics, and user behavior. These internal representations allow server to recommend counterintuitive but effective task reorderings or resource allocations that are difficult to derive with simplified rule sets.

Alternative embodiments are also possible. Server may employ a recurrent neural network architecture instead of a transformer-based model, in which case server processes the prompt sentence token by token through recurrent units, maintaining hidden states that encode context. Server may compress operation schedule and inventory context into a numerical vector using an encoder network and then use a separate decoder network to generate advice text. Server may integrate reinforcement learning methods wherein the reward signal is derived from long-term improvements in operation result information, allowing the model to optimize policies that go beyond immediate user acceptance.

Server may also vary the way prompt sentences are structured. In one variation, server generates prompts that contain explicit delimiters and key-value formatting, such as: “USER: U001; TASK: T1005; RESOURCE: R10; TIME: 09:00-10:30; ITEM_A: stock=15, required=20; ITEM_B: stock=50, required=10. Based on this, propose the next optimal work sequence and any replenishment actions.” The use of such semi-structured prompts facilitates more accurate extraction of entities from model outputs and further improves technical reliability.

In all embodiments, server, terminal, and user cooperate such that the generative AI model and prompt sentence processing are tightly integrated with concrete data structures, learning mechanisms, and decision-support flows implemented at the computer-technical level. The system thereby goes beyond abstract steps of “analyzing data” and “displaying results,” and instead provides specific mechanisms and data flows that improve processing speed, recommendation accuracy, data management, and computational efficiency within the computing environment.

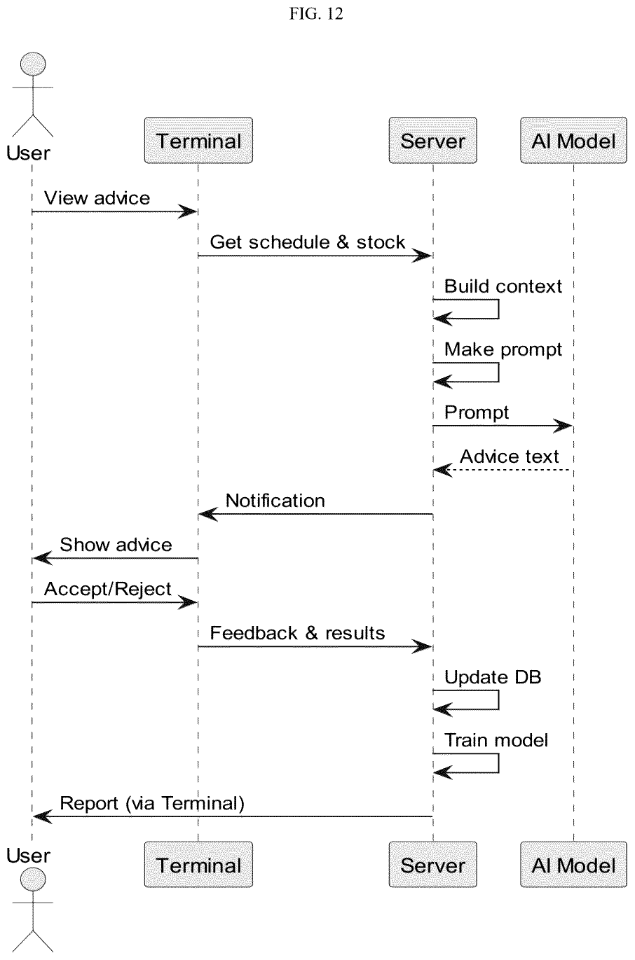

The following describes the processing flow using FIG. 12.

### Step 1:

Server initializes system modules and loads models.

Server receives as input configuration parameters, model files stored in storage, and schema definitions of schedule and inventory tables. Server loads an operating system process, initializes a database connection, and imports data-processing libraries and a generative AI framework. Server reads the generative AI model configuration, including embedding size, number of layers, attention heads, and vocabulary, and loads trained weights into memory. Server outputs initialized module instances, including a schedule management module, an inventory management module, a prompt generation module, a generative AI interface module, an advice post-processing module, a feedback collection module, an aggregation module, and a model training module.

### Step 2:

Server acquires and organizes operation schedule information.

Server receives as input raw schedule data from external systems or terminals, including user identifiers, task identifiers, resource identifiers, planned time windows, and priorities. Server stores these records in a relational database and then loads them into in-memory table-like structures. Server performs data cleaning by converting timestamps to a unified time zone, resolving missing values, and validating identifiers against reference tables. Server groups and sorts tasks by user and by start time, and computes derived fields such as remaining time until start and expected end time. Server outputs normalized schedule tables indexed by user and resource.

### Step 3:

Server acquires and organizes inventory information.

Server receives as input raw inventory records from a warehouse or resource management system, including item identifiers, current stock quantities, reserved quantities, and safety stock thresholds. Server loads these records into in-memory tables and numerical arrays. Server computes available stock by subtracting reserved quantities from current stock and compares available stock with safety thresholds. Server also joins the inventory tables with bill-of-materials data to determine which items are required for each scheduled task. Server outputs, for each user and task, an associated list of required items with available stock, required quantities, and shortage indicators.

### Step 4:

Server constructs user-specific context structures.

Server receives as input the normalized schedule tables and the enriched inventory tables. Server performs join operations to associate each user's upcoming tasks with their required items, along with shortage flags. Server calculates feature vectors per task, including remaining time, expected duration, inventory surplus/deficit, and historical delay statistics if available. Server aggregates these features into a context structure per user that contains an ordered list of tasks and corresponding resource and inventory states. Server outputs structured context objects ready for conversion into prompt sentences.

### Step 5:

Server generates a prompt sentence for the generative AI model.

Server receives as input a user-specific context object. Server selects a prompt template based on context type, for example, a template for near-term scheduling within a specified time horizon. Server inserts into the template concrete data such as user identifier, task identifiers, resource identifiers, scheduled time windows, and item stock/requirement numbers. Server concatenates these elements into a natural-language prompt sentence. Server may, for example, generate:

“Generative AI model, based on the following context: User U001 is scheduled for Task T1005 on Resource R10 from 09:00 to 10:30. Required items are Item A (current stock 15 units, required 20 units) and Item B (current stock 50 units, required 10 units). Please propose the next optimal work sequence and concrete advice to avoid delays, including whether to reorder tasks or trigger replenishment.”

Server outputs the generated prompt sentence as a text string.

### Step 6:

Server converts the prompt sentence into model input tensors.

Server receives as input the prompt sentence. Server applies a tokenizer to split the sentence into tokens and to map each token to a token identifier. Server converts the list of token identifiers into a fixed-length or dynamically sized sequence, adding special tokens such as start-of-sequence and end-of-sequence identifiers. Server then looks up embeddings for each token identifier using the model's embedding matrix, producing a two-dimensional tensor of embedding vectors. Server outputs the embedding tensor and any auxiliary masks (such as attention masks) required by the generative AI model.

### Step 7:

Server executes the generative AI model to generate advice information.

Server receives as input the embedding tensor and attention masks. Server feeds these tensors into the neural network, which includes multiple self-attention and feedforward layers. Server performs a sequence of matrix multiplications and non-linear activations to propagate representations through the network. During decoding, server applies a decoding algorithm such as beam search or top-k sampling, repeatedly feeding back previously generated tokens to generate the next token until an end-of-sequence token or maximum length is reached. Server outputs a sequence of output token identifiers representing the model-generated advice.

### Step 8:

Server post-processes the generated advice text.

Server receives as input the sequence of output token identifiers. Server converts these identifiers back into a natural-language text string. Server then parses this text using pattern-matching rules and, if necessary, a lightweight classifier to extract structured elements such as task identifiers, time adjustments, item identifiers, and action types. Server validates the extracted elements against the schedule and inventory tables to verify that referenced tasks and items exist and that proposed time changes are technically feasible. Server corrects or discards inconsistent parts of the advice according to predefined rules. Server outputs validated advice information including a machine-readable representation and a human-readable summary.

### Step 9:

Server converts advice information into notification information and sends it to terminals.

Server receives as input the validated advice information. Server constructs notification payloads by assigning a title, a message body, severity or priority flags, and optional action labels such as “Accept plan” and “Reject plan.” Server determines the target terminal based on the intended user and the user's current device registration. Server transmits the notification payload over a communication channel, such as a push-notification service, and logs the event. Server outputs the delivery status and a reference to the sent notification.

### Step 10:

Terminal receives and displays the notification to the user.

Terminal receives as input the notification payload from server. Terminal parses the payload to extract the title, body, and action buttons. Terminal presents these elements on a display, possibly accompanied by auditory or tactile alerts. Terminal shows, for example, “Postpone Task T1005 by 30 minutes and start Task T1006 on Resource R11 now. Replenish 50 units of Item A.” Terminal outputs a visual interface element that allows user to select one of multiple response options.

### Step 11:

User reviews the advice and selects a response.

User receives as input the displayed notification and the contextual information on the terminal screen. User evaluates whether the suggested plan is feasible given the real-world situation, such as machine availability or safety constraints. User performs a physical interaction with the terminal, such as tapping an “Accept” button, tapping a “Reject” button, or opening a details view and entering a comment. User outputs a decision, which is captured as response information by the terminal.

### Step 12:

Terminal sends response information and operation result information to server.

Terminal receives as input user's selection and any entered comments. Terminal packages this into a response message including user identifier, advice identifier, response type (accept, reject, modify), timestamp, and optional free-text comments. Terminal may also send operation result information when tasks start or complete, including actual start and end times and realized throughput. Terminal transmits these messages to server using an application programming interface. Terminal outputs confirmed delivery information or retries transmission in case of temporary communication failure.

### Step 13:

Server stores feedback and updates schedule and inventory data.

Server receives as input response information and operation result information from terminals. Server writes these records to dedicated tables linking them with the originating advice, prompt sentence, and context. Server adjusts the schedule tables according to accepted changes, updating task start and end times and status flags. Server updates inventory projections by adjusting expected consumption and recording replenishment requests when indicated. Server recomputes derived features such as average delay or resource utilization. Server outputs updated schedule and inventory tables and updated interaction history records.

### Step 14:

Server prepares learning data and updates the generative AI model.

Server receives as input historical prompt sentences, generated advice information, response information, and operation result information. Server selects instances in which advice led to favorable outcomes, such as accepted recommendations that reduced delay. Server constructs training pairs where each input is a prompt sentence or encoded context and each target is a desirable advice text or structured plan. Server computes numeric feature representations for these inputs and targets and stores them in training datasets. Server executes a training procedure that computes a loss function (for example, cross-entropy between predicted and target tokens), calculates gradients, and updates model weights using an optimization algorithm. Server outputs an updated generative AI model with modified parameters and records model version metadata.

### Step 15:

Server aggregates multi-user data to generate management and evaluation information.

Server receives as input updated schedule data, inventory data, response data, and operation result data across all users. Server groups and aggregates these data by resource, item, task category, or user cohort to compute metrics such as average delay, frequency of stockouts, and advice acceptance rates. Server analyzes these metrics to identify patterns indicating strengths and weaknesses of the organization, such as resources that consistently perform well or items that repeatedly cause bottlenecks. Server composes aggregate information and evaluation information in both structured and textual formats suitable for presentation in management dashboards or reports. Server outputs management information and evaluation information that higher-level users can view and use to adjust system parameters, resources, or policies.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented management systems for monitoring work progress typically rely on static dashboards and manually designed rules executed by general-purpose processors. In such systems, a server periodically collects structured task data from user terminals and computes simple numerical indicators such as completion percentages or counts of overdue tasks. Although these operations are automated, the underlying processing pipeline is rigid: the server applies predefined queries and fixed visualization logic, and the system cannot flexibly interpret free-form status descriptions or generate nuanced evaluations without human intervention.

This rigid architecture leads to several technical problems in computer operation and resource utilization. First, when a large volume of heterogeneous progress data and free-description text is accumulated in a storage device, the server must either ignore most of the unstructured content or perform costly ad hoc analysis outside the main processing pipeline. As a result, the processor and memory subsystem are underutilized in terms of their capability to extract higher-order information, while network and storage resources are consumed by repeatedly transmitting and storing low-level raw data that is not effectively synthesized. Second, typical systems separate numerical aggregation logic and report generation logic from any intelligent analysis components. If an artificial intelligence service is used at all, it is often invoked manually and independently of the automated data collection cycle. This decoupled design forces the server to execute additional application code for pre- and post-processing around the AI service, increasing latency and introducing redundant data transformations. The processor repeatedly converts internal data structures to ad hoc input formats and back, which degrades throughput and complicates scaling as the number of users grows.

Third, known systems usually do not employ a structured prompt generation mechanism integrated into the server's core workflow. When a generative AI service is queried, the prompt sentence is often constructed in a non-systematic manner or by a human operator, which leads to inconsistent analysis quality and limits the ability of the server to automatically optimize the prompt according to current database content, reporting period, or manager-requested viewpoint. This inconsistency prevents the processor from deterministically leveraging the generative AI model as a functional component within the control flow of the system.

Fourth, conventional report-delivery mechanisms do not tightly couple real-time data ingestion with real-time AI-based synthesis. While some systems support scheduled report generation, they generally update only numerical charts based on simple queries and do not regenerate AI-derived evaluations in response to each new data transmission. Consequently, the server cannot provide a manager terminal with continuously updated, AI-refined views of organization-wide work status, and computational resources of both the server and the external AI infrastructure remain underused between scheduled runs.

Therefore, there is a need for an improved computer-implemented system and server-side processing method that: (i) integrates data collection, aggregation, prompt sentence generation, and invocation of a generative AI model into a unified control flow executed by a processor; (ii) automatically transforms raw, heterogeneous work progress information and state description information into structured, manager-oriented report information; and (iii) enables real-time or near-real-time regeneration and delivery of AI-enhanced reports without manual intervention, thereby improving the effectiveness, efficiency, and scalability of the overall information processing performed by the computer system.

The specific processing by the specific processing unit 290 of the data processing device 12 in Example 2 is realized by the following means.

The present invention provides a server comprising a processor and a storage device, the processor being configured to cooperate with one or more information terminals operated by users and with a data management apparatus, to acquire work progress information and state description information from the information terminals via a communication network, to store the acquired work progress information and state description information in an information storage unit of the data management apparatus, to retrieve from the information storage unit, for a plurality of users, the stored work progress information and state description information, to calculate for each user at least one progress indicator and at least one delay indicator and generate aggregated work information based on the calculated indicators, to generate a prompt sentence for input to a generative information processing mechanism from input information including the aggregated work information, to cause the generative information processing mechanism to analyze the aggregated work information based on the prompt sentence and generate analysis result information including work evaluation information and guidance proposal information for a manager, to structure manager-oriented report information based on the analysis result information and the calculated indicators so as to generate report information including visualization information and explanatory text information, and to transmit the report information to an information terminal operated by the manager in response to real-time or on-demand requests. This enables the processor to implement, as a unified and repeatable control flow, an automated cycle of data collection, aggregation, prompt construction, generative AI-based analysis, and structured report delivery, thereby improving the efficiency and scalability of computer-based processing of heterogeneous work progress data, reducing redundant transformations and manual intervention, and providing the manager terminal with continuously updated, AI-enhanced visibility into organization-wide work status and risk.

The term “user” refers to an individual who operates an information terminal and provides work-related input, including work progress information and state description information, to the system.

The term “manager” refers to a user who supervises one or more other users and who receives manager-oriented report information generated by the system in order to oversee work status, capabilities, and risks of a managed group.

The term “information terminal” refers to an electronic device operated by a user or a manager, including but not limited to a computing device such as a personal computer, a mobile communication device, or a tablet device, that executes an application or browser and transmits or receives data via a communication network.

The term “server” refers to an electronic computing apparatus, including at least one processor and at least one memory, that executes programs to perform data acquisition, storage control, data processing, prompt generation, interaction with a generative information processing mechanism, and report delivery.

The term “processor” refers to a hardware processing unit, such as a central processing unit or a processing core, configured to execute instructions to implement the functions of acquiring, storing, aggregating, analyzing, and transmitting data as defined in the claims.

The term “storage device” refers to one or more non-transitory computer-readable media, including but not limited to semiconductor memory, magnetic storage, or optical storage, that store programs, data, and intermediate results used by the processor.

The term “communication network” refers to a wired or wireless communication infrastructure, including but not limited to a local area network, a wide area network, or a packet-switched network, through which the server, the data management apparatus, and the information terminals exchange information.

The term “data management apparatus” refers to an electronic apparatus including at least one processor and at least one storage unit that manages persistent storage, retrieval, and organization of work progress information and state description information for a plurality of users.

The term “information storage unit” refers to a logical or physical storage area, such as a database or a data table, that stores work progress information, state description information, indicators, and report information under control of the data management apparatus or the server.

The term “work progress information” refers to structured data representing a state of execution of work by a user, including at least one of a task name, a progress rate, a planned completion date, or other quantitative or categorical indicators of task status.

The term “state description information” refers to unstructured or semi-structured textual information entered by a user in a free-description format and describing a qualitative state of work, such as obstacles, next steps, or contextual explanations related to work progress.

The term “progress indicator” refers to a computed metric derived from work progress information, representing a degree of completion or advancement of work for a user or a task over a given period.

The term “delay indicator” refers to a computed metric derived from work progress information and planned completion dates, representing a degree of schedule deviation, lateness, or risk of delay for a user or a task.

The term “aggregated work information” refers to combined and processed information generated from a plurality of users' work progress information, state description information, progress indicators, and delay indicators, organized in a form suitable for analysis and reporting.

The term “generative information processing mechanism” refers to an information processing system, including a generative AI model, that receives a prompt sentence as input and generates output information by performing probabilistic or neural network-based generation or transformation of natural language or structured data.

The term “generative AI model” refers to a machine-learned model that, in response to an input prompt sentence and associated data, generates natural language text or structured output by applying learned parameters to input tokens.

The term “prompt sentence” refers to textual input, optionally including embedded structured data, that specifies an analysis task or output requirement and is provided to the generative information processing mechanism as a control instruction for generating analysis result information.

The term “analysis result information” refers to output information generated by the generative information processing mechanism based on the prompt sentence and the aggregated work information, including at least work evaluation information and guidance proposal information for a manager.

The term “work evaluation information” refers to analysis result information that evaluates work status, performance, or abilities of users or groups based on aggregated work information.

The term “guidance proposal information” refers to analysis result information that proposes actions, advice, or coaching measures for a manager to provide to users, based on the evaluation of work status and risks.

The term “manager-oriented report information” refers to information structured for presentation to a manager, including at least visualization information, explanatory text information, and optionally metrics or summaries, to provide an overview of work status, ability tendencies, and risk factors of a managed group.

The term “visualization information” refers to graphical or structured elements, such as charts, graphs, or tables, that visually represent progress indicators, delay indicators, or other metrics within the manager-oriented report information.

The term “explanatory text information” refers to narrative text, generated at least in part from the analysis result information, that explains work status, evaluation, and recommended actions in natural language for the manager.

The term “report information” refers to a combination of visualization information, explanatory text information, and underlying metrics, structured for delivery from the server to an information terminal for display to a user or a manager.

The term “real time” refers to a condition in which acquisition of work progress information, generation of analysis result information, and transmission of updated report information are performed with a latency sufficiently low that a manager can monitor substantially current work status.

The term “instruction information” refers to input data provided by a manager to the server, including commands or parameters requesting generation or update of manager-oriented report information.

The term “report request information” refers to instruction information that explicitly specifies a request for generation, retrieval, or update of manager-oriented report information for a predetermined period or scope.

The term “managed group” refers to a set of users whose work progress information and state description information are subject to evaluation and reporting for a particular manager.

In one embodiment, a server cooperates with a plurality of terminals and users to implement the claimed system. The server includes at least one processor, a main memory, a non-transitory storage device, and a network interface. The terminal includes a processor, a memory, an input unit, a display, and a communication interface. The user operates the terminal to input work-related information, and the server executes stored programs to perform data aggregation, prompt sentence generation, interaction with a generative AI model, and report generation.

The server executes an operating system such as a general-purpose server operating system and runs an application stack including, for example, an HTTP server (such as a web server process), an application framework (such as a web application framework), and a database client. The server accesses a database system running on a data management apparatus, such as a relational database management system, via a database protocol. The terminal executes an operating system such as a mobile operating system or a desktop operating system and runs a client application in the form of a native application or a web browser. The terminal displays user interfaces and sends data to the server using a secure network protocol such as HTTPS over TCP/IP.

The server stores in non-transitory memory a program that defines specific data structures used for internal processing. The server uses a row-oriented table in the database system for a work log, including fields such as: a user identifier, a manager identifier, a project identifier, a task identifier, a progress rate, a planned completion date, a timestamp, and a free-text status description. The server uses another table for reports, including: a report identifier, a manager identifier, a coverage period, numerical indicators, references to generated visual elements, and generated explanatory text.

The terminal stores in local memory a temporary buffer of unsent work progress information. The terminal internally represents this buffer as a record list, each record including a task name, a progress rate, a planned completion date, and a status description string. The terminal uses this buffer to handle intermittent network connectivity and to support retransmission when necessary. The terminal formats these records into a structured payload and transmits them to the server. The terminal displays confirmation messages and later displays manager-oriented reports received from the server.

The server receives incoming payloads from terminals via the network interface. The server parses the payloads into internal record structures in main memory. The server performs validation of data types, ranges, and referential relationships. For example, the server checks that the user identifier matches a registered user entry in a user master table, that the progress rate is within a valid numeric range, and that the planned completion date is representable in its temporal data type. The server writes validated records to the work log table in the database using transaction-controlled insert operations.

The server retrieves, based on program logic, sets of work log records for a plurality of users associated with a particular manager or group. The server uses set-based database queries to fetch all work log records within a specified time interval and for a specified group. The server then constructs, in main memory, data structures that group records by user and by task. For each user, the server computes progress indicators such as an average progress rate across tasks, a completion ratio of tasks whose status indicates completion, and a trend value derived from differences between successive updates. The server computes delay indicators such as the difference between the planned completion date and the current date for incomplete tasks, and a lateness score for tasks whose completion timestamp exceeds the planned completion date.

The server stores these computed indicators in an in-memory aggregation structure, such as an associative map from user identifiers to indicator vectors. The server then transforms this aggregation structure into a form suitable for inclusion in a prompt sentence. The server serializes numerical indicators as textual descriptions (for example, “User U001 has an average progress rate of 65% and 2 overdue tasks”) and interleaves these descriptions with selected free-text status descriptions. This transformation is performed using deterministic concatenation rules and formatting rules so that the resulting prompt is consistent in structure across repeated executions.

The server generates a prompt sentence for input to a generative AI model. The server executes a prompt construction module that uses a template with fixed instruction segments and variable data segments. For example, the server constructs a prompt sentence such as: “Analyze the following team work progress data and generate a concise management report. For each user, evaluate the current progress and work abilities, identify any schedule risks or delays, and propose concrete coaching suggestions for the manager. Use clear headings and bullet points.

### Data:

User U001: Average progress 65%, Overdue tasks 2, Status: ‘The progress of Project A is 50%. The next step is the final review of the design. I am waiting for feedback from the design lead.’
User U002: Average progress 80%, Overdue tasks 0, Status: ‘Implementation is almost complete. Remaining tasks are integration tests and documentation.’”

The server can generate alternative prompt sentences according to a manager's request, such as:

“Please analyze my team's project status for this week and generate a management report that focuses on schedule delays, workload imbalance, and suggestions for reassigning tasks. Summarize the main risks and recommend mitigation actions.”

The server calls a generative AI model that is implemented as a transformer-based neural network and is deployed on a remote computing environment. The generative AI model has multiple transformer layers, each layer having a multi-head self-attention sub-layer and a feed-forward sub-layer. The generative AI model internally represents input tokens as high-dimensional vectors and performs attention computations using query, key, and value matrices. The generative AI model parameters include weight matrices for each attention head and feed-forward layer, and bias terms. The generative AI model has been trained on large-scale textual corpora using a sequence-to-sequence or language modeling objective with a loss function such as cross-entropy. During training, the model parameters were updated using gradient-based optimization such as stochastic gradient descent or a variant thereof. The generative AI model is configured to accept prompt sentences and to generate output tokens that form an analysis result.

The server sends the prompt sentence and the embedded data to the generative AI model by issuing a request over the network, for example via an HTTPS-based API. The server encodes the prompt sentence into request fields and transmits them together with model selection parameters and inference parameters such as maximum output length and output randomness control parameters. The generative AI model applies its trained parameters to the input token sequence, computes attention scores across all tokens, and generates an output sequence of tokens. The output sequence includes multiple sections with headings, per-user analysis paragraphs, and manager-oriented recommendations.

The server receives the generated text from the generative AI model and stores it temporarily in main memory. The server parses the text using rule-based segmentation, for example detecting headings by pattern matching or delimiters, and associates analysis segments with corresponding user identifiers. The server aligns the generative AI output with the computed progress and delay indicators to create a structured representation of the analysis result. The server optionally stores this structured representation in the database, linking it to the corresponding report record.

The server constructs manager-oriented report information that includes both visualization elements and explanatory text. The server uses the progress indicators and delay indicators to generate numerical datasets for charts such as bar charts showing per-user progress or line charts showing progress across time. The server uses a chart rendering library, which may run on the server or on the manager's terminal, to generate machine-readable representations of the charts. The server packages chart configuration data and the generative AI text into a report representation in a markup or structured format suitable for presentation to the terminal.

The terminal operated by the manager receives the report representation from the server. The terminal renders the charts and explanatory text on its display using a rendering engine such as a browser engine or a native UI toolkit. The terminal arranges the content in sections that allow the manager to quickly identify high-risk users, tasks with significant delays, and recommended coaching actions. The terminal can also provide interactive controls that allow the manager to switch between time periods or filter specific groups. The server supports these interactions by performing additional database queries and by generating updated prompt sentences and analyses when necessary.

The server improves computer technology in several respects. The server reduces redundant data transformations by using a consistent intermediate aggregation structure for both numerical computations and prompt sentence generation. This reuse of a single aggregation structure reduces memory allocations and serialization overhead, leading to improved processing throughput. The server also applies selective inclusion of data in the prompt sentence based on computed importance scores, for example omitting records with stable on-time performance and focusing on delayed or high-risk records. This selection reduces the volume of data sent to the generative AI model and lowers communication load and model inference time. The server thereby reduces network bandwidth usage and remote computation costs.

The server improves the accuracy and stability of AI-generated reports by controlling the prompt sentence structure and content according to deterministic formatting rules. The server always places high-level instructions at the beginning of the prompt, followed by a consistent sequence of user-level data lines. This structure helps the generative AI model allocate attention to relevant tokens, improving reliability and making the AI output more predictable. Compared to manual prompt construction or ad hoc query composition, this structured prompt generation leads to reduced variance in analysis quality and reduced need for manual post-editing.

The server applies a particular post-processing algorithm to segment and normalize AI output. For example, the server enforces a rule that each user's analysis appears under a dedicated heading where the user identifier matches the internal user identifier. When the generative AI model output deviates from expected patterns, the server applies heuristic corrections, such as re-ordering or filtering lines that do not reference recognized user identifiers. This post-processing improves the technical robustness of the system by preventing malformed or ambiguous AI output from propagating directly to the user interface.

The server executes the generative AI model as part of an integrated feedback loop. Each time a terminal transmits updated work progress information, the server updates indicators, reconstructs the prompt sentence, and triggers a new AI analysis. This loop results in frequent, incremental updates instead of batch processing at long intervals. The server thus maintains a near-real-time representation of organization-wide status. The server employs caching and incremental aggregation, so that only indicators for users with new work log entries are recomputed. This incremental approach reduces computational load and improves response time when a manager requests an updated report.

The terminal benefits from reduced computational requirements because the intensive operations of aggregation, prompt generation, and AI inference execution occur on the server side. The terminal mainly handles user interaction, data entry, and display logic. By offloading complex processing to the server, the system allows low-powered terminals to participate, such as lightweight mobile devices. The terminal also benefits from standardized data formats from the server, simplifying local parsing and rendering.

The user experiences improved feedback due to the AI-enhanced analysis. The user does not manually aggregate complex metrics or generate structured textual summaries. Instead, the user only enters task-level progress and status descriptions. The server uses these inputs, together with the generative AI model, to produce synthesized reports that include ability evaluations and coaching suggestions. However, the technical contribution is not limited to assistance for human decision-making; the system also provides concrete improvements in data management, computational efficiency, and system scalability.

In another embodiment, the server employs an alternative generative AI model architecture, such as an encoder-decoder network trained on structured input sequences and report-style output sequences. The server may pre-encode a fixed schema representation of aggregated work data and then concatenate it with instruction tokens. The encoder transforms the structured data into a latent representation, and the decoder generates report text conditioned on both the latent representation and the instruction tokens. The training of this encoder-decoder model uses a supervised learning dataset of input-output pairs where input sequences contain user-level metrics and status snippets, and output sequences contain manager-style reports. The loss function in training may include not only token-level accuracy but also additional regularization terms that encourage correct coverage of key metrics. This embodiment provides improved alignment between numerical data and textual narrative. In a further embodiment, the server combines rule-based analysis with generative AI analysis. The server first applies deterministic rules to identify extreme conditions, such as users with more than a threshold number of overdue tasks. The server then annotates the prompt sentence with explicit flags, for example “This user is classified as high risk according to internal rule R1.” The generative AI model uses these flags to focus its narrative on such high-risk users. This combination of deterministic rules and AI attention improves accuracy and ensures that critical conditions are not missed even if the AI model output varies.

In yet another embodiment, the server adjusts inference parameters for the generative AI model based on system load and required turnaround time. For example, when the number of users is high and the report must be produced within a tight latency bound, the server reduces the maximum output length and narrows the scope of requested analysis. The server may also adjust sampling parameters to produce more deterministic output. This dynamic control improves the scalability and responsiveness of the system and demonstrates an adaptation of AI computation to technical constraints of the computing environment.

The system is not limited to work progress management in business organizations. The server can be configured to process other types of time-series status data, such as maintenance logs in an industrial environment or learning progress in an educational environment. In each case, the server aggregates structured indicators and unstructured descriptions, constructs a domain-specific prompt sentence, and invokes a generative AI model to synthesize analysis and recommendations. The underlying technical mechanisms of data aggregation, prompt generation, AI invocation, and structured report construction remain the same and continue to improve the computer's ability to store, process, and present complex, heterogeneous data in a scalable and efficient manner.

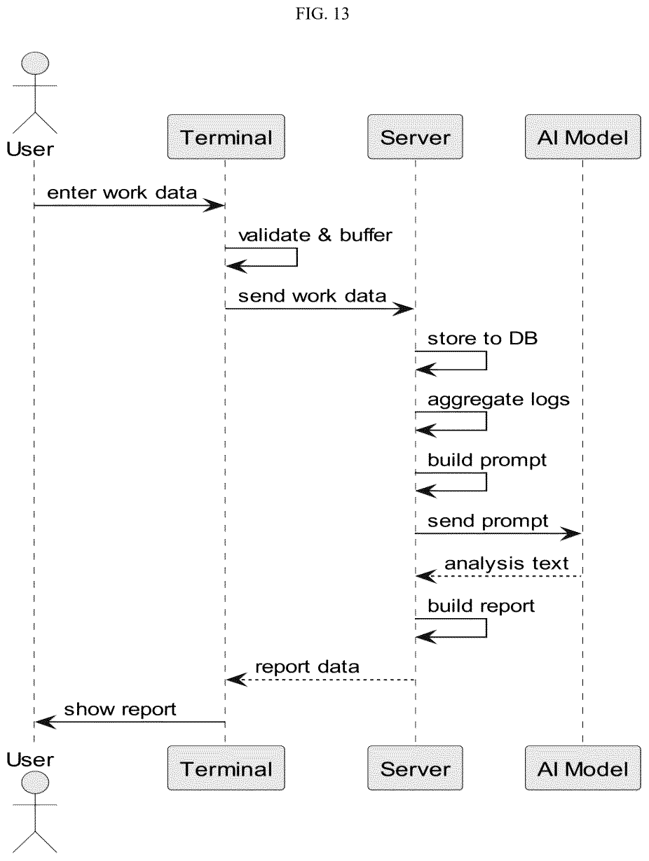

The following describes the processing flow using FIG. 13.

### Step 1:

The user operates the terminal to input work progress information. The user selects or enters a task name, sets a progress rate, specifies a planned completion date, and types a free-text status description.

Input: Human-entered task data (task name, progress rate, planned completion date, status description).

Output: Structured work progress record stored in terminal memory.

The terminal receives the user input via a graphical user interface, validates formats (for example, checks that the progress rate is numeric and within 0-100, and that the date is in a valid format), and then converts the validated input into an internal record structure with explicit fields for user identifier, task identifier, timestamps, and text fields. The terminal stores this record in a local buffer for later transmission.

### Step 2:

The terminal transmits work progress records to the server. The terminal groups one or more buffered records into a transmission payload and sends the payload over a secure network connection.

Input: Locally buffered work progress records on the terminal.

Output: HTTP request containing structured work progress data delivered to the server; local records marked as “sent.”

The terminal encodes the work records into a structured format (for example, a key-value representation), attaches authentication information, and issues an HTTPS request to a predefined server endpoint. The terminal then monitors the response status; when the server returns a success status code, the terminal updates the local buffer to mark the corresponding records as successfully transmitted or removes them from the buffer.

### Step 3:

The server receives the transmitted work progress data and stores it in a persistent data management apparatus.

Input: Network payload containing work progress records from one or more terminals.

Output: Validated and normalized work log entries stored in a database table.

The server parses the incoming payload into internal data objects, checks the authentication token, and performs validation of fields such as user identifier, task identifier, progress rate, and date values. The server then converts these data objects into database rows and executes insertion or update commands against a work log table. The server ensures referential integrity by verifying that each user identifier and task identifier matches an existing entry in corresponding master tables before committing the transaction.

### Step 4:

The server aggregates stored work logs into per-user indicators.

Input: Work log entries retrieved from the database for a specified time range and user set.

Output: Aggregated work information containing progress indicators and delay indicators for each user.

The server issues selection queries to retrieve all work log rows relevant to a manager's group and time period. The server groups the retrieved rows by user and by task in working memory. For each user, the server calculates numerical values such as average progress rate, number of completed tasks, number of overdue tasks, and delay durations (for example, days past the planned completion date). The server then constructs an aggregation structure where each user identifier maps to a set of computed indicators and selected representative status descriptions, thereby transforming raw rows into summarized per-user metrics.

### Step 5:

The server generates a prompt sentence for a generative AI model using the aggregated work information.

Input: Aggregated work information including per-user indicators and representative status descriptions.

Output: Prompt sentence text that embeds the aggregated work information and instructions for analysis.

The server applies a formatting routine that converts each user's indicators into textual descriptions (for example, “User U001: Average progress 65%, Overdue tasks 2”) and appends the user's latest status description. The server then inserts these descriptions into a predefined prompt template that contains fixed instruction segments. The server concatenates the instruction segments and the per-user data lines into a single prompt sentence, ensuring consistent ordering and separation markers so that the generative AI model can reliably parse and attend to the relevant parts of the input.

### Step 6:

The server sends the prompt sentence to the generative AI model and obtains an analysis result.

Input: Prompt sentence constructed from aggregated work information.

Output: Analysis result information containing work evaluations and guidance proposals in natural language.

The server invokes an external or internal generative AI endpoint, providing the prompt sentence and inference parameters (such as maximum output length and determinism settings). The generative AI model tokenizes the prompt, processes the tokens through its transformer layers using stored weight parameters, and generates output tokens that form a structured narrative. The server receives this generated text as an analysis result, which includes sections for overall status, per-user comments, and suggested actions. The server stores the analysis result in working memory for further processing.

### Step 7:

The server post-processes the analysis result and combines it with numerical indicators to construct a manager-oriented report.

Input: Analysis result text from the generative AI model and the previously computed progress and delay indicators.

Output: Structured report data including visualization-ready numerical datasets and explanatory text segments.

The server segments the analysis result into logical sections, identifies user-specific parts by matching user identifiers or names, and aligns each section with the corresponding user's indicators. The server constructs chart datasets from the numerical indicators (for example, arrays of progress rates per user) and constructs text sections from the aligned narrative. The server thereby generates a composite report structure that pairs each chart or table with a corresponding explanatory text section, ready for presentation on the manager's terminal.

### Step 8:

The server delivers the structured report to the manager's terminal.

Input: Manager-oriented report structure consisting of visualization datasets and explanatory text.

Output: Response payload transmitted to the manager's terminal for display.

The server packages the report structure into a response format appropriate for the manager's display environment, such as a markup document or a structured data representation. The server then transmits this package over the network to the manager's terminal in response to a report request or an automatic update trigger. The server may also include metadata such as the report generation time and covered period to enable the terminal to label the report correctly.

### Step 9:

The terminal operated by the manager renders the received report and supports interactive inspection.

Input: Report payload received from the server containing chart datasets and explanatory text sections.

Output: Visualized report displayed on the terminal screen, with user-selectable views and filters.

The terminal decodes the received payload and constructs on-screen elements such as charts, tables, and text blocks. The terminal binds chart datasets to visual components and lays out the explanatory text adjacent to corresponding visuals. The terminal allows the manager to scroll, expand, or filter sections (for example, by user or by project), and updates the displayed content accordingly. When the manager requests a refreshed view or changes filters, the terminal can send new requests to the server, which in turn can repeat aggregation, prompt generation, and AI analysis based on updated work logs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented assistant systems and monitoring systems typically treat (i) natural-language interaction, (ii) operational data analysis, and (iii) user emotion handling as separate subsystems. Such systems often provide static rule-based responses to user input, perform isolated analytics on machine or business data, and do not unify these functions in a single orchestrated architecture driven by prompt sentences to a generative AI model. As a result, these systems suffer from several technical problems. First, existing systems generally lack a processor-level mechanism that can take heterogeneous inputs—including prompt sentences, high-volume sensor streams from machines, multi-user work logs, and continuously updated emotion signals—and transform them into consistent internal representations that are suitable for end-to-end optimization of both information processing and control signal generation. This leads to fragmentation of data paths, redundant computation, and increased latency when deriving actionable instructions for equipment control and user support.

Second, current architectures typically do not integrate generative AI models into the core control and monitoring loop in a structured manner. Generative AI models, if used at all, are often attached as superficial chat layers that merely produce textual advice, without being systematically supplied with normalized operational indicators and organizational performance metrics, and without providing outputs that are automatically mapped to machine control protocols or workflow orchestration. This limits the technical effect of such models on the underlying computing system, reduces automation, and forces human operators to manually translate AI output into concrete control actions.

Third, many systems are unable to adapt service timing and content to a user's real-time emotional state in a technically coherent manner. Emotion analysis engines may be present, but they are not tightly coupled with the generative AI model inputs and outputs, nor with the scheduling and prioritization logic of the processor. Consequently, notifications, workload adjustments, and relaxation suggestions are produced in a static or poorly timed fashion, which can overload users, increase context switches, and degrade effective system throughput and user performance.

Fourth, existing enterprise or factory systems often treat each user or each machine as an isolated endpoint and lack a processor-level mechanism that automatically collects and fuses multi-user, multi-machine, and multi-emotion data into higher-level organizational performance indicators. Without such integrated indicators, it is difficult for the processor to generate global optimization strategies, to support supervisor-level overviews, or to allow intelligent agents associated with different users to exchange information so as to compute strengths and weaknesses of an organization.

Accordingly, there is a need for an improved computer-implemented system in which a processor is specifically configured to (1) generate and manage intelligent assistance functions for individual users, (2) receive and process prompt sentences with a generative AI model in conjunction with structured work and machine data, (3) perform emotion analysis and adjust services at the processor level, (4) automatically translate high-level AI-derived proposals and user instructions into low-level control signals for machines using machine control communication protocols, and (5) compute and exploit organization- or process-level performance indicators. By tightly integrating these components, the processor can improve the technical functioning of the overall computer system, including data routing, resource utilization, response timing, robustness of control, and the precision of AI-driven decisions.

The specific processing by the specific processing unit 290 of the data processing device 12 in Application Example 2 is realized by the following means.

The present invention provides a server comprising a processor configured to generate, for each user, an intelligent assistance function having a personalized support capability based on task history information and behavior history information and to provide the intelligent assistance function to a terminal associated with the user; to receive, via the terminal, at least one prompt sentence including a natural-language instruction from the user or from a supervisor, and to input the prompt sentence together with associated work data into a generative AI model so as to obtain, from the generative AI model, an analysis result from which the processor selects or generates a service corresponding to work-support processing or equipment-control processing; to apply an emotion analysis engine to at least one of voice information, image information, and biometric information acquired from the user in order to estimate an emotional state of the user, and to adjust provision of the service by dynamically modifying, based on the estimated emotional state and the analysis result of the generative AI model, at least one of advice content, notification timing, and load-adjustment content generated by the intelligent assistance function; to collect sensor data from a plurality of work-target machines or facilities, to compute operation-status indicators based on the sensor data, to convert the operation-status indicators into display data for the terminal and provide the display data as a visual monitoring screen, and to further input at least one of the prompt sentence and the operation-status indicators into the generative AI model so that the generative AI model generates at least one of a production-process improvement proposal and a control-instruction proposal; to convert, based on at least one of the control-instruction proposal output by the generative AI model and an operation instruction received from the user, an abstract, high-level work instruction into a control signal conforming to a machine-control communication protocol, and to transmit the control signal to at least one of the work-target machines and the facilities so as to change an operation condition thereof; and to integrate work data, the operation-status indicators, and the emotional-state information relating to a plurality of users and a plurality of work-target machines or facilities, to compute performance indicators for at least one of an organizational unit and a process unit, and to input the performance indicators together with a prompt sentence from a manager into the generative AI model so that the generative AI model generates an analysis result including at least one of strengths, weaknesses, and improvement measures for at least one of an entire organization and an entire process, and to provide the analysis result as a report to the terminal. This enables the processor to technically improve overall system operation by unifying heterogeneous data streams into a single processing pipeline, by using the generative AI model as a core decision engine tightly coupled with structured operational indicators and emotion states, by automatically translating high-level AI-derived decisions into low-level control signals for machines, and by generating organization-level optimization strategies, thereby reducing manual intermediate steps, lowering processing latency, improving resource utilization and responsiveness, and enhancing the reliability and adaptability of computer-implemented monitoring, control, and assistance functions.

The term “processor” refers to a hardware information-processing unit, such as a central processing unit or a processing circuit, configured to execute instructions of a program and to perform arithmetic, logical, control, and data-management operations.

The term “user” refers to a human operator or individual for whom an intelligent assistance function is generated and who interacts with the system through a terminal.

The term “terminal” refers to an information-processing apparatus, such as a mobile device, a wearable device, or a stationary computing device, that provides an input/output interface between the user and the processor.

The term “intelligent assistance function” refers to a software-implemented capability executed under control of the processor that provides personalized support to a user, including generating advice, scheduling operations, adjusting workload, and presenting information based on data associated with the user.

The term “personalized support capability” refers to a property of the intelligent assistance function whereby behavior is adapted to characteristics of an individual user, including at least one of preferences, task history, behavior history, and performance patterns.

The term “task history information” refers to data describing tasks previously assigned to or executed by a user, including at least one of task identifiers, categories, timestamps, completion states, and performance measures.

The term “behavior history information” refers to data describing actions and patterns of a user in interacting with systems and resources, including at least one of login times, resource access logs, communication records, and application usage patterns.

The term “work data” refers to structured or semi-structured information related to activities of a user or an organization, including at least one of task data, schedule data, progress data, and communication data.

The term “prompt sentence” refers to a natural-language text input that expresses an instruction, query, or request and that is provided by a user, a supervisor, or the system itself for processing by a generative AI model.

The term “generative AI model” refers to a machine-learning model configured to generate output information, including natural-language text, based on input data such as a prompt sentence and context information, and implemented for example as a neural-network-based language model.

The term “analysis result of the generative AI model” refers to output data generated by the generative AI model, including at least one of classifications, summaries, recommendations, control-instruction proposals, and improvement proposals.

The term “service” refers to a unit of processing or functionality provided by the system, including at least one of work-support processing, schedule management, notification generation, information retrieval, and equipment-control processing.

The term “work-support processing” refers to processing that assists execution of tasks by a user, including at least one of prioritizing tasks, allocating time, suggesting procedures, and generating explanatory information.

The term “equipment-control processing” refers to processing that results in generation or modification of control signals for machines or facilities, including at least one of starting, stopping, adjusting speed, or otherwise changing an operation condition.

The term “emotion analysis engine” refers to a software component or a combination of software and models configured to estimate an emotional state of a user based on input such as voice information, image information, text information, or biometric information.

The term “emotional state” refers to a classification or representation of a user's affective condition, including at least one of stress, relaxation, happiness, anger, anxiety, or satisfaction, and optionally an intensity value thereof.

The term “voice information” refers to audio data obtained from speech or sound produced by a user and processed as digital signals.

The term “image information” refers to still-image or moving-image data obtained from an imaging device, such as a camera, and including at least a facial region or body posture of a user.

The term “biometric information” refers to physiological or behavioral data of a user, including at least one of heart rate, skin conductance, respiration, motion sensor readings, and keystroke patterns.

The term “service provision” refers to a process in which the system outputs or executes a service for a user, including at least one of displaying information, sending notifications, scheduling events, and transmitting control signals.

The term “load-adjustment content” refers to information or operations that change a workload assigned to a user, including at least one of rescheduling tasks, reassigning tasks, or inserting breaks.

The term “work-target machine” refers to an automated apparatus used for performing a physical or logical task in a process, such as a production machine, a robot, or a processing device, whose operation can be monitored and controlled by the system.

The term “facility” refers to an installation or equipment unit, including at least one of a production line, a conveyor system, or an environmental device, that is monitored or controlled by the system.

The term “sensor data” refers to measurement values acquired from one or more sensors associated with a work-target machine or a facility, including at least one of temperature, speed, position, state flags, error codes, and throughput counts.

The term “operation-status indicator” refers to a derived value or set of values calculated from sensor data and representing a state of operation of a work-target machine or a facility, including at least one of utilization, cycle time, error frequency, and throughput.

The term “display data” refers to data formatted for visual output on a terminal, including at least one of numerical values, icons, charts, and textual descriptions derived from operation-status indicators.

The term “visual monitoring screen” refers to a user interface screen displayed on a terminal that presents operation-status indicators or related information in a visual form for observation and supervision.

The term “production-process improvement proposal” refers to information generated by the generative AI model that describes a recommended change to at least one parameter or step of a process in order to improve performance indicators such as throughput, latency, or error rate.

The term “control-instruction proposal” refers to an abstract representation of one or more control actions suggested by the generative AI model, including at least one of increasing or decreasing speed, pausing operation, reordering tasks, or changing setpoints.

The term “operation instruction” refers to a command or directive provided by a user through the terminal to modify behavior of a work-target machine, a facility, or a service.

The term “high-level work instruction” refers to an abstract, human-understandable description of a desired change in operation, such as a natural-language instruction or a symbolic command, that is not yet encoded in a machine-control protocol format.

The term “machine-control communication protocol” refers to a communication scheme used for transmitting control signals between the processor and a work-target machine or a facility, including but not limited to fieldbus protocols, industrial Ethernet protocols, or application-layer device protocols.

The term “control signal” refers to a formatted data unit transmitted according to a machine-control communication protocol that causes a work-target machine or a facility to change its operation state or parameters.

The term “operation condition” refers to a state or set of parameters defining behavior of a work-target machine or a facility, including at least one of speed, mode, target setpoint, start/stop state, and scheduling status.

The term “organizational unit” refers to a grouping of users or resources within an organization, such as a department, team, division, or plant.

The term “process unit” refers to a logical or physical segment of an overall process, such as a production line segment, a workflow stage, or a service pipeline.

The term “performance indicator” refers to a metric computed from work data, operation-status indicators, and emotional-state information that expresses performance of an organizational unit or a process unit, including at least one of productivity, efficiency, quality, and stability measures.

The term “analysis result” refers to an output generated by the generative AI model based on input data, including descriptive or prescriptive information such as explanations, strengths, weaknesses, and improvement measures.

The term “strength” refers to a favorable condition or advantage associated with an organizational unit or a process unit, as identified in the analysis result.

The term “weakness” refers to an unfavorable condition or limitation associated with an organizational unit or a process unit, as identified in the analysis result.

The term “improvement measure” refers to a recommended action or strategy that, when implemented, is intended to enhance at least one performance indicator or mitigate at least one weakness.

The term “report” refers to a structured output provided to a terminal and including at least part of the analysis result, optionally combined with numerical indicators, tables, or graphical elements.

The term “supervisor” refers to a user having an authority to oversee one or more other users or organizational units and to receive overviews and analysis results from the system.

The term “intelligent assistance function associated with a supervisor” refers to an intelligent assistance function configured for a supervisor and adapted to provide aggregated views, organizational analyses, and management-level recommendations.

The term “intelligent assistance function associated with a subordinate” refers to an intelligent assistance function configured for a non-supervisory user and adapted to provide support related to that user's own tasks and conditions.

The term “information exchange” refers to a process in which intelligent assistance functions or system components transmit and receive data, including at least one of work data, operation-status indicators, and emotional-state information, for joint analysis or coordination.

The term “overview form” refers to a representation in which information regarding multiple users, machines, or units is summarized and abstracted for high-level understanding, rather than presented as detailed raw data.

The server, the terminal, and the user cooperate to implement embodiments of the present invention. In the following description, the “server” denotes an information-processing apparatus comprising at least one processor, memory, storage, and communication interfaces. The “terminal” denotes an information-processing apparatus used by the user or supervisor, such as a mobile device, a wearable device, or a stationary computing device. The “user” denotes a human operator who interacts with the system.

The server executes a stored program that is structured as a plurality of software modules, including at least an intelligent assistance module, a generative AI interface module, an emotion analysis module, a machine monitoring and control module, a performance aggregation module, and a data management module. The server stores these modules in non-transitory computer-readable media, and the processor loads and executes them under an operating system.

The server generates, for each user, an intelligent assistance function having a personalized support capability. The server uses a data management module to maintain structured data sets representing task history information and behavior history information for each user. The server stores such data sets in a relational database, such as an SQL database, or in a document-oriented database, such as a key-value store. The server represents task history information as records including task identifiers, categories, start and end timestamps, completion flags, and performance scores. The server represents behavior history information as records comprising login times, resource access logs, communication channel identifiers, and application usage metrics.

The server applies a profiling algorithm implemented by the intelligent assistance module. The server aggregates per-user task and behavior records into feature vectors. The server may compute a feature vector including, for example, an average task completion time, a distribution of task categories, a frequency of work in particular time windows, and a ratio of interrupted to uninterrupted work sessions. The server stores the resulting feature vectors as profile parameters for each user. The server thereby initializes and constantly updates the personalized support capability of the intelligent assistance function.

The terminal provides an interface through which the user interacts with the intelligent assistance function. The terminal may execute a native application or a web application. The terminal displays lists of tasks, schedules, and notifications derived from the user's profile and work data. The terminal acquires user inputs such as natural-language messages, button selections, and parameter adjustments and transmits them to the server via a network using protocols such as HTTPS or WebSockets.

The user interacts with the intelligent assistance function by providing prompt sentences. The user inputs prompt sentences in a natural-language format, for example:

“Analyze this month's project progress and propose three concrete improvement actions for my team.”

“Set a reminder for tomorrow's 10:00 meeting and also summarize my main tasks for this week.”

“Evaluate the current production line efficiency and propose improvements. At the same time, assess operators' stress levels and propose specific advice to reduce stress.”

The server receives a prompt sentence from the terminal and associates it with the user's identifier. The generative AI interface module constructs an input for a generative AI model. The server selects a language-model-based generative AI model, for example, a transformer-type neural-network architecture having multiple self-attention layers, feed-forward layers, and layer normalization. The server encodes the prompt sentence together with contextual information, such as the user's feature vector and relevant work or machine data, into a token sequence suitable for the generative AI model.

The server uses a tokenizer to convert the prompt sentence and context text into discrete tokens. The server then maps each token to an embedding vector using a learned embedding matrix. The server feeds the sequence of embeddings into the transformer layers. Each transformer layer computes attention scores between all pairs of tokens, multiplies them with the embeddings, and produces context-aware hidden states. The server uses multiple transformer layers in succession to refine these hidden states. The server applies a final linear layer and a softmax function to predict output tokens that form a natural-language response or a structured representation, such as a list of recommended actions.

The server configures the generative AI model with hyperparameters, such as a number of layers, attention heads, embedding dimensions, and learning rates. During model training, the server uses a loss function such as cross-entropy between the model's predicted token distribution and the ground-truth token distribution. The server updates model weights using a gradient-based optimization algorithm, such as stochastic gradient descent with momentum or adaptive moment estimation. The server may perform further fine-tuning of the generative AI model on domain-specific corpora comprising project reports, machine logs, and annotated examples of recommendations and control instructions. The server may also perform data augmentation by paraphrasing prompt sentences, injecting noise into text or features, or sampling different subsets of context, in order to improve robustness and reduce overfitting.

The server applies specific rules to the generative AI output to convert it into actionable services. The server parses the generated text and uses pattern-matching or lightweight classification networks to extract structured entities, such as time expressions, task names, machine identifiers, and recommended parameter changes. The server then uses rule-based logic and mapping tables to decide which service or combination of services to execute, such as creating tasks, scheduling reminders, updating user profiles, or generating control signals for machines. This multi-stage processing chain, which combines neural-network-based text generation with deterministic mapping and validation, improves reliability and safety of system behavior compared to a direct free-form text output.

The server implements an emotion analysis module to estimate an emotional state of each user. The server receives voice information, image information, and biometric information from the terminal or from external sensors. The server may use a combination of models: a convolutional neural network for facial expression classification, a recurrent or transformer model for speech signal features, and a statistical or neural classifier for biometric signals. For example, the server may extract Mel-frequency cepstral coefficients and pitch-related features from audio waveforms, compute face embeddings from image frames using a convolutional neural network, and compute time-domain and frequency-domain features from heart rate and skin conductance signals.

The server concatenates these features into a joint feature vector. The emotion analysis module applies a classifier, such as a feed-forward neural network with fully connected layers and nonlinear activation functions, to map the joint feature vector to discrete emotion labels and continuous intensity scores. The server trains the classifier using supervised learning with labeled emotion data and uses a loss function such as categorical cross-entropy or mean squared error. The server periodically or incrementally updates classifier parameters based on new labeled data or user corrections, thereby improving accuracy over time.

The terminal acquires the raw data for emotion analysis. The terminal may capture video using a camera to obtain frames that include the user's face, capture audio using a microphone while the user speaks, and acquire biometric signals from wearable sensors via a local wireless link. The terminal can perform preliminary processing, such as down-sampling, compression, face detection, or voice activity detection, to reduce communication load before sending the processed data to the server. This reduces bandwidth and processing load on the server without sacrificing essential features needed for emotion estimation.

The user can enable or disable emotion monitoring and can correct estimated emotions. The user can review a history of inferred emotional states on the terminal and manually label particular segments. The server receives these manual labels and incorporates them into subsequent training or fine-tuning steps of the emotion analysis models, thus improving classification performance and personalization.

The server adjusts service provision based on emotional state and generative AI analysis results. The intelligent assistance module receives both the analysis result from the generative AI model and the current emotional state from the emotion analysis module. The server evaluates policy rules specifying, for example, that when a user is stressed, the system postpones non-urgent notifications, reduces task load suggestions, or presents only compressed summaries. The server may generate a message, using the generative AI model, tailored to the emotional state, such as:

“The user is currently in a meeting and appears nervous. Generate a short, polite message suggesting a brief relaxation technique, suitable to show on a mobile device, and ask for confirmation before starting.”

The server then outputs a response generated by the generative AI model, such as a suggestion for a 2-minute breathing exercise, and the terminal displays the message with confirmation options.

The server implements a machine monitoring and control module to connect the intelligent assistance function with real-world equipment. The server receives sensor data from work-target machines or facilities via industrial communication protocols such as a fieldbus protocol, an industrial Ethernet protocol, or a device-specific application protocol. The server treats raw sensor streams as time-stamped records containing machine identifiers, state flags, error codes, cycle times, throughputs, and other measured variables. The server stores such records in time-series tables.

The server computes operation-status indicators from the sensor data. The server uses the machine monitoring and control module to aggregate data by machine, time interval, or process segment, and to compute derived values such as utilization, average cycle time, maximum temperature, or error rates. The server may apply outlier detection and filtering algorithms to remove anomalous sensor readings. The server represents operation-status indicators as compact feature vectors or summary records, which are then used both for visualization and as inputs to the generative AI model.

The terminal presents operation-status indicators to users as a visual monitoring screen. The terminal requests summary data from the server at specified intervals or upon user request. The terminal renders charts, tables, and color-coded indicators that highlight machines or facilities with low utilization, high error frequency, or abnormal operating conditions. The terminal may display trend graphs of specific indicators so that supervisors or operators can monitor the system state.

The user inspects the monitoring screen and may issue equipment-related prompt sentences.

The user can input natural-language requests such as:

“Analyze the operation data of Robot A and identify bottlenecks in the supply line. Propose at least three concrete countermeasures.”

“Evaluate the current production line efficiency based on sensor data, identify bottlenecks, and propose improvements. At the same time, assess operators' stress levels from emotion data and propose specific advice or break schedules.”

The server receives such prompt sentences and integrates them with current operation-status indicators and, if needed, operator emotional-state information.

The server passes these combined inputs to the generative AI model. The server encodes both textual prompt sentences and numerical operation-status indicators into a hybrid input representation. The server may convert numerical indicators into textual descriptions or into additional feature vectors concatenated with language embeddings. The generative AI model then produces an analysis result that includes identification of probable bottlenecks, suggested parameter adjustments, recommended re-scheduling, or allocation changes. This fusion of real-time machine data and natural-language reasoning enables AI-driven optimization that is closely coupled to actual machine operations.

The server then maps abstract control-instruction proposals into concrete control signals. The machine monitoring and control module receives abstract proposals such as “reduce speed of machine X by 20% for one hour” or “pause machine Y for maintenance.” The server uses mapping tables and scaling functions to derive precise values for control registers or protocol messages. For example, the server can convert a 20% speed reduction proposal into a specific register write operation setting a speed setpoint to 80% of its current value. The server formats such data into protocol-specific frames and transmits the frames to the corresponding machine or facility over the industrial network.

The server thereby modifies operation conditions of machines and facilities. The server receives acknowledgments from controlled devices and logs success, failure, or parameter constraints. The server then re-computes operation-status indicators, which reflect new operating conditions. This closed feedback loop enables machine control based on generative AI analysis and demonstrates a concrete technical use of AI outputs beyond mere textual presentation.

The server computes performance indicators for organizational units and process units. The performance aggregation module collects work data, operation-status indicators, and emotional-state information for multiple users, machines, and processes. The server constructs higher-level metrics such as productivity, throughput, error rates, and average stress levels for a department, team, or production line. The server may store these metrics in specialized data structures for multi-dimensional analysis, for example, tables indexed by unit and time, or vector representations for each unit.

The server then uses a generative AI model to interpret and summarize such performance indicators. The server constructs prompt sentences that encapsulate managerial questions, such as:

“Given the following organizational KPIs and trends, and this manager's question ‘Identify the main weaknesses of the current workflow and propose improvements’, generate a detailed but concise report.”

The server includes numerical performance indicators and derived trends as part of the context. The generative AI model then generates an analysis result describing strengths, weaknesses, and improvement measures. The terminal visualizes this result in text form together with charts of underlying metrics.

The user, in the role of a supervisor, receives an overview of organizational performance and can issue further prompt sentences. The supervisor can request comparisons between units, hypothetical scenario evaluations, or detailed action lists. The server processes these prompt sentences in the same way, using combined inputs from performance indicators and model-based reasoning.

The server also coordinates information exchange between intelligent assistance functions associated with different users. The server may implement a publish-subscribe mechanism or shared memory structures in which intelligent assistance instances can write aggregated, anonymized statistics and read summary data about related users or units. The server then constructs joint prompt sentences for a generative AI model, such as: “Using shared information from assistants A, B, and C, estimate the strengths and weaknesses of the associated team and propose coordination strategies.”

The generative AI model generates team-level or organization-level recommendations, which the server stores and distributes to supervisor terminals.

The described architecture results in technical improvements to computing behavior. The server reduces redundant data processing by centralizing feature extraction and profile management and by representing diverse inputs in common feature structures. The use of transformer-based generative AI models tightly integrated with structured indicators allows the server to perform complex inferences and planning steps that are computationally optimized compared to ad-hoc rule systems. The server reduces communication and computation overhead by pre-processing data at the terminal, using compressed features for emotion analysis and monitoring, and implementing efficient database schemas that support incremental updates.

The server improves processing speed and responsiveness by caching profile data and operation-status summaries, thus avoiding repeated recomputation. The server reduces errors and improves precision by combining multiple modalities (tasks, sensors, emotion) and by using training procedures with explicit error functions and weight updates that are optimized for the specific domain. The server improves resource utilization on the network and on processors by performing selective sampling and batch processing of data, and by dynamically adjusting data collection rates based on observed variability and relevance. The system's use of AI differs from a mere automation of human mental steps. The server employs neural-network-based architectures that operate on high-dimensional vector spaces, learn complex, non-linear relationships from training data, perform internal representation learning, and apply systematic algorithms for gradient-based optimization. The server uses specific, non-conventional processing sequences: for example, converting raw machine sensor data and emotional-state information into hybrid embeddings that the generative AI model consumes; using the model's output not only as text but as structured templates for control signals; and integrating these steps into feedback loops where data flows continuously between sensors, AI modules, and actuators. These computational processes and data flows are not simply a codification of human reasoning, but provide technical advantages in terms of speed, scalability, and adaptability when managing complex, multi-modal systems.

In alternative embodiments, the server may use different types of generative AI models, such as sequence-to-sequence models with recurrent units, encoder-decoder transformer models, or hybrid architectures that include graph neural networks for representing process structures. The server may also use different feature sets for emotion analysis, such as additional physiological signals or interaction logs. The terminal may be implemented as augmented-reality glasses, voice-only devices, or multi-screen dashboards. The communication protocols between the server and machines may vary depending on industrial standards. However, in all such embodiments, the server, the terminal, and the user cooperate according to the claimed configuration to unify prompt-driven AI reasoning, emotion-aware assistance, machine monitoring and control, and organization-level performance analysis within a single, technically integrated system.

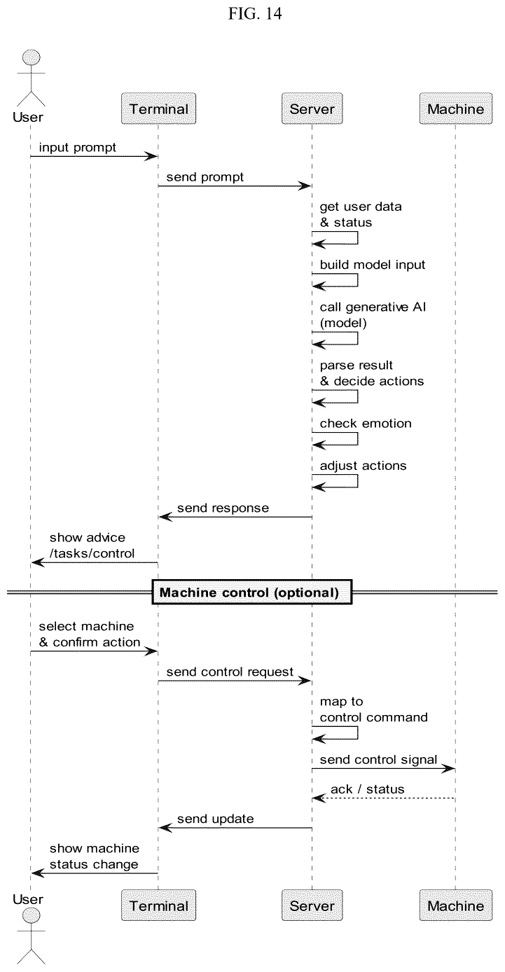

The following describes the processing flow using FIG. 14.

### Step 1:

The server initializes core modules and data structures.

The server loads an intelligent assistance module, a generative AI interface module, an emotion analysis module, a machine monitoring and control module, and a data management module from non-transitory storage into memory.

The input is configuration data including database connection parameters, model endpoints, and protocol settings.

The server parses the configuration, allocates memory for caches and queues, and establishes connections to databases and external APIs.

The output is an initialized runtime environment in which subsequent user, terminal, and machine interactions can be processed.

### Step 2:

The terminal registers a user and sends initial profile information to the server.

The terminal collects identification data, time-zone settings, language preferences, and optionally job role and department from user input fields.

The input is the user's manually entered registration data.

The terminal packages these data into a structured message and transmits the message to the server via a secure communication channel.

The output is a registration request received by the server.

### Step 3:

The server creates a user record and initializes task and behavior history.

The server receives the registration request from the terminal and writes a new user record into a user table in a database.

The input is the registration message containing user identification and preferences.

The server assigns a unique user identifier, initializes empty task history and behavior history tables linked to this identifier, and stores default parameters for the intelligent assistance function.

The output is a persistent user profile and associated empty history structures in the database.

### Step 4:

The user records tasks and work activities through the terminal.

The user enters task descriptions, deadlines, priorities, and completion statuses using forms or a task list interface on the terminal.

The input is the user's textual descriptions and selected options.

The terminal validates the input, converts each task into a structured record, and sends these records to the server as work data updates.

The output is a stream of work data messages transmitted to the server.

### Step 5:

The server updates task history and behavior history.

The server receives work data messages from the terminal and parses them into internal data objects.

The input is task creation, update, and completion records, as well as implicit behavior signals such as timestamps and interaction types.

The server inserts new task entries into a task history table, updates existing records, and logs behavior events such as task view times and application usage.

The output is updated task history information and behavior history information for the user.

### Step 6:

The server computes a user feature vector for personalization.

The server retrieves recent task history and behavior history records for the user from the database.

The input is a set of records including task categories, completion times, working hours, and interaction frequencies.

The server aggregates these records by applying data operations such as counting, averaging, and histogram generation to compute features like average completion time per category, preferred working time windows, and interruption rates.

The output is a numerical feature vector representing the user's work patterns and preferences.

### Step 7:

The server updates the intelligent assistance function configuration.

The server takes the user feature vector as an input to a profiling routine within the intelligent assistance module.

The input is the computed feature vector and the user's explicit preference settings.

The server adjusts parameters such as default notification times, task ranking weights, and recommended workload thresholds by performing linear and non-linear transformations on the feature values.

The output is an updated configuration profile that defines how the intelligent assistance function behaves for the user.

### Step 8:

The terminal acquires emotion-related signals from the user.

The terminal activates sensors such as a microphone, a camera, and connected biometric devices during authorized periods.

The input is raw audio waveforms, image frames including the user's face, and biometric measurements such as heart rate and skin conductance.

The terminal performs pre-processing operations including resampling, noise reduction, face detection, and basic feature extraction to reduce data size and enhance signal quality, then transmits processed features or compressed signals to the server.

The output is a stream of emotion-related data sent to the server.

### Step 9:

The server estimates the user's emotional state.

The server receives the emotion-related data from the terminal and passes them to the emotion analysis module.

The input is audio features, image features, and biometric features for a specific time window.

The server normalizes feature values, concatenates them into a joint feature vector, and feeds the vector into a trained classifier model that computes probabilities for emotion classes and an intensity value.

The output is an estimated emotional state, such as “stressed” with a numerical intensity score.

### Step 10:

The user submits a prompt sentence to request support or analysis.

The user opens a chat or command interface on the terminal and types a natural-language prompt sentence.

The input is free-form text such as “Analyze this month's project progress and propose three concrete improvement actions for my team.”

The terminal captures the string, associates it with the user identifier, and sends it as a message to the server.

The output is a prompt sentence message received by the server.

### Step 11:

The server constructs a generative AI model input from the prompt sentence and context.

The server receives the prompt sentence message and retrieves the user's feature vector, recent task history, and, if relevant, current operation-status indicators for machines and recent emotional-state estimates.

The input is the prompt sentence text and contextual data records.

The server concatenates textual context into a formatted sequence, tokenizes the sequence into tokens, and converts tokens into embedding vectors. The server may also encode numerical indicators into textual descriptions or additional vectors and merge them with language embeddings.

The output is a sequence of embeddings or encoded representations ready for processing by the generative AI model.

### Step 12:

The server invokes the generative AI model and obtains an analysis result.

The server sends the encoded model input to a generative AI model implemented as a neural-network-based transformer.

The input is the sequence of embeddings representing the prompt sentence and associated context.

The server causes the model to propagate the embeddings through attention layers and feed-forward layers, computes logits for output tokens, applies a softmax function to obtain token probability distributions, and samples or selects tokens to build an output sequence. The output is a generated text sequence or structured representation that constitutes an analysis result, such as a set of recommended actions or a control-instruction proposal.

### Step 13:

The server post-processes the generative AI model output to derive actionable items.

The server receives the generated text sequence and passes it to a parsing routine.

The input is the raw output text or structured representation from the generative AI model.

The server applies pattern-matching rules, regular expressions, or lightweight classification to extract entities such as time expressions, task names, machine identifiers, parameter changes, and priority levels, and it arranges them into a structured list of actionable items.

The output is a data structure containing explicit actions, each with associated parameters.

### Step 14:

The server adjusts actions based on the user's emotional state.

The server obtains the latest emotional-state estimate for the user from the emotion analysis module.

The input is the structured list of actionable items and the emotional-state label with intensity. The server applies decision rules that, for example, downgrade non-urgent notifications when the user is stressed, insert break suggestions when workload is high and stress intensity is above a threshold, or compress explanations when the user appears overloaded.

The output is a modified set of actions and messages tailored to the user's current emotional condition.

### Step 15:

The server updates user-level work-support services.

The server maps each adjusted action to a concrete service, such as task creation, reminder scheduling, or message generation.

The input is the list of modified actions and the user's profile.

The server performs database operations to insert new tasks, updates schedule entries, or constructs user messages by combining template components with generated text.

The output is committed updates in the work data and a set of messages ready to be sent to the terminal.

### Step 16:

The terminal presents recommendations and options to the user.

The terminal receives messages and task updates from the server via the network.

The input is response data containing text recommendations, new tasks, and reminders.

The terminal renders the information as a list of suggestions, buttons such as “Apply this plan”, “Ask for alternative”, and detailed views of suggested changes, using its graphical user interface components.

The output is a visual and interactive presentation of AI-assisted support on the terminal screen.

### Step 17:

The user accepts, rejects, or modifies suggested actions.

The user examines the proposed actions and uses the terminal interface to confirm, decline, or edit specific recommendations.

The input is the displayed suggestions and associated controls.

The terminal converts user decisions into action feedback records and sends them to the server.

The output is a set of feedback messages that indicate which actions should be executed, modified, or discarded.

### Step 18:

The server executes confirmed work-support actions and logs feedback.

The server receives feedback messages and determines which actions are confirmed.

The input is the user's decisions for each suggested action.

The server executes corresponding operations, such as updating task statuses, changing deadlines, or recording notes, by performing appropriate database updates and external API calls, and logs the outcome and user feedback for future model refinement.

The output is an updated state of work data and stored feedback for training or tuning.

### Step 19:

The server collects sensor data from work-target machines and facilities.

The server establishes connections to machines and facilities via machine-control communication protocols.

The input is raw sensor messages containing timestamps, machine identifiers, state flags, and measured values.

The server decodes protocol frames, normalizes values, and writes records into time-series tables for each machine or facility.

The output is a set of persisted sensor data representing the current and recent operation of machines and facilities.

### Step 20:

The server computes operation-status indicators.

The server queries time-series tables for sensor data within specified time intervals.

The input is a collection of sensor readings grouped by machine and time window.

The server performs aggregations such as summation, averaging, min/max operations, and error counting to derive indicators like utilization, average cycle time, and error frequency, and stores these indicators in summary tables.

The output is a matrix or table of operation-status indicators indexed by machine and interval.

### Step 21:

The terminal requests and displays machine status.

The terminal sends a status request to the server to retrieve operation-status indicators.

The input is a request specifying time range and machine selection.

The server responds with indicator values, and the terminal draws charts, tables, and color-coded indicators that visualize which machines are underperforming or exhibiting abnormal behavior.

The output is an updated visual monitoring screen for the user.

### Step 22:

The user issues a machine-related prompt sentence.

The user observes the monitoring screen and types a prompt sentence such as “Analyze the operation data of Robot A and identify bottlenecks in the supply line. Propose at least three concrete countermeasures.”

The input is the natural-language prompt sentence referencing one or more machines.

The terminal forwards the prompt sentence and relevant selection context (e.g., machine identifier and time range) to the server.

The output is a machine-analysis request message received by the server.

### Step 23:

The server combines the machine-related prompt sentence with operation-status indicators and invokes the generative AI model.

The server receives the machine-analysis request and retrieves the corresponding operation-status indicators and, if applicable, associated operator emotional-state data.

The input is the prompt sentence and the numerical indicators.

The server converts numerical indicators into contextual descriptions or auxiliary vectors, concatenates them with the prompt sentence embeddings, and sends them to the generative AI model, which produces an analysis text identifying bottlenecks and concrete countermeasures.

The output is a generated analysis result focusing on machine and process optimization.

### Step 24:

The server translates abstract countermeasures into machine-level control-instruction proposals.

The server parses the analysis result to extract recommended machine actions, such as speed reductions, buffer adjustments, or schedule changes.

The input is the text analysis result containing countermeasure descriptions.

The server applies rule mappings to convert textual descriptions into structured commands specifying machine identifiers, parameters, and durations.

The output is a set of high-level control-instruction proposals for specific machines or facilities.

### Step 25:

The server converts high-level control instructions into protocol-specific control signals.

The server processes each control-instruction proposal, retrieves current machine parameters if necessary, and computes new target values.

The input is the structured high-level control-instruction proposals and current machine settings.

The server encodes these values into control messages conforming to a selected machine-control communication protocol and transmits these messages to the relevant devices, then waits for acknowledgment.

The output is a sequence of transmitted control signals that change operation conditions of the machines or facilities.

### Step 26:

The terminal presents control-related confirmations to the user.

The terminal receives confirmation or error responses from the server concerning executed control signals.

The input is a status message indicating success or failure of each control action.

The terminal displays notifications or logs showing which changes were applied and, in case of failure, which constraints prevented execution.

The output is an updated operations view including outcomes of AI-assisted control.

### Step 27:

The server aggregates multi-user, multi-machine, and multi-emotion data to compute performance indicators.

The server retrieves work data, operation-status indicators, and emotional-state information for multiple users and machines over a chosen period.

The input is a set of records covering at least one organizational unit or process unit.

The server performs multi-dimensional aggregations and statistical computations, such as averages, variances, correlations, and trend estimates, to derive performance indicators like productivity, error rates, downtime, and average stress levels.

The output is a performance-indicator data set for organizational and process analysis.

### Step 28:

The user in a supervisory role issues a management-level prompt sentence.

The user, acting as a supervisor, types a prompt sentence such as “Using the latest task completion data and communication logs, evaluate the work ability of each team member and summarize their strengths and weaknesses in a concise report.”

The input is the management-level prompt sentence.

The terminal sends the sentence along with identifiers of the relevant organizational unit to the server.

The output is a supervisory analysis request received by the server.

### Step 29:

The server inputs performance indicators and the management-level prompt sentence into the generative AI model to produce a report.

The server retrieves the performance-indicator data set for the specified organizational unit.

The input is the prompt sentence and the aggregated performance indicators.

The server formats the indicators as structured context and feeds the combined input into the generative AI model, which generates a report text describing strengths, weaknesses, and improvement measures.

The output is a natural-language report suitable for presentation to the supervisor.

### Step 30:

The terminal displays the generated report and associated metrics.

The terminal receives the report text and performance-indicator summaries from the server.

The input is the analysis report and numeric indicators.

The terminal renders the report in a readable layout, side-by-side with charts representing the underlying metrics, and allows the supervisor to scroll, search, or export the content.

The output is an interactive supervisory dashboard displaying AI-generated organizational insights.

### Step 31:

The user provides feedback on AI-generated analyses and actions.

The user, whether an individual worker or a supervisor, can rate the usefulness of recommendations, annotate incorrect suggestions, or override proposed actions through the terminal interface.

The input is the displayed AI outputs and the user's feedback operations.

The terminal encodes this feedback into labeled data items and sends them to the server.

The output is a collection of feedback records stored by the server.

### Step 32:

The server uses feedback to refine models and rules.

The server periodically processes feedback records and associates them with corresponding model inputs and outputs.

The input is the set of feedback items linked to specific prompt sentences, context data, and analysis results.

The server updates training sets, recalculates loss functions on recent examples, and performs additional training or fine-tuning of the generative AI model and emotion classifiers, and may adjust rule weights in the post-processing pipeline.

The output is updated model parameters and rule configurations that improve future prediction accuracy, recommendation quality, and system responsiveness.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

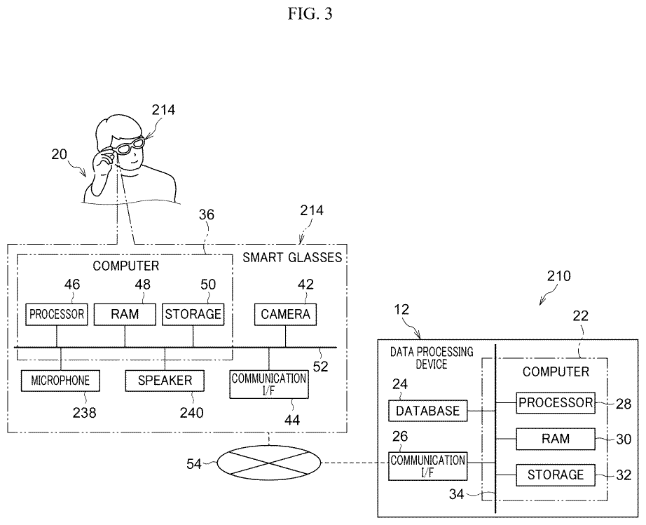

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

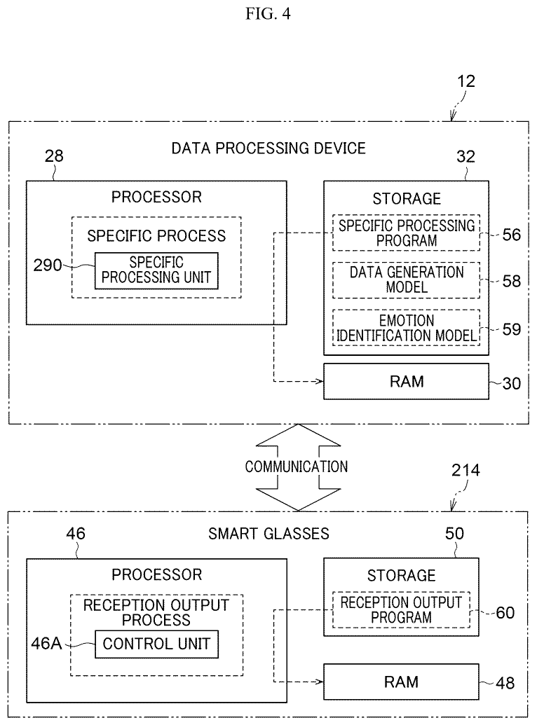

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

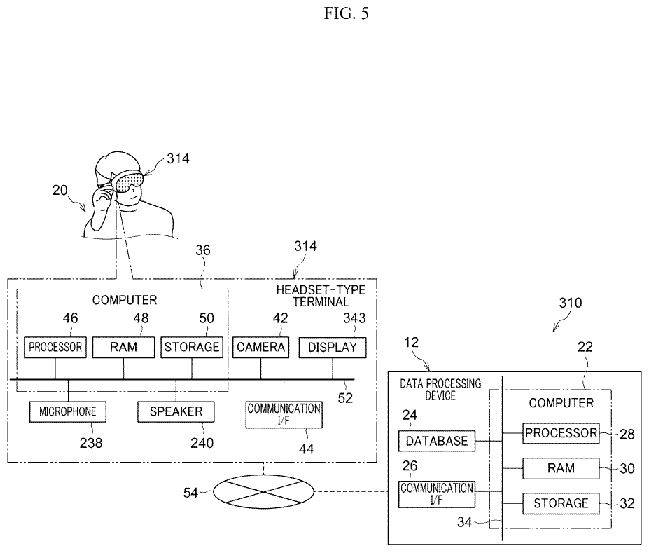

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

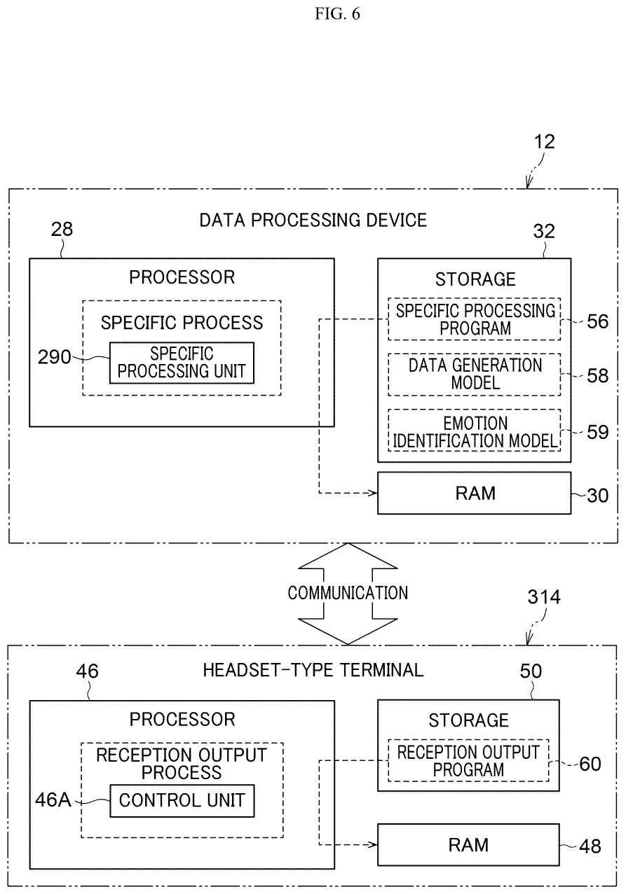

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

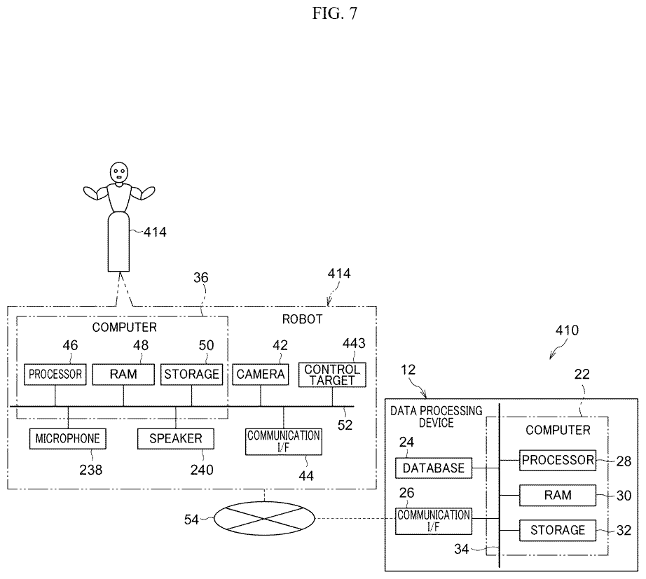

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

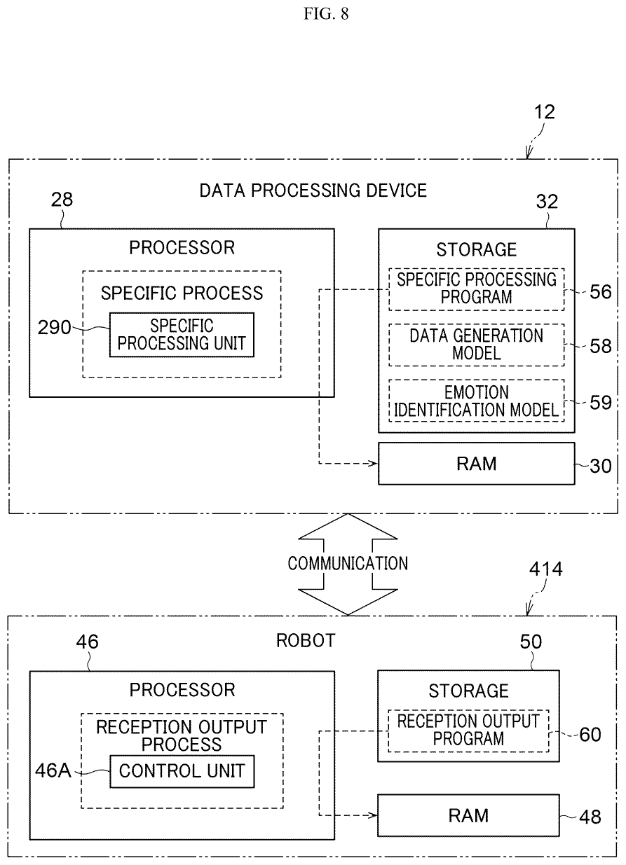

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

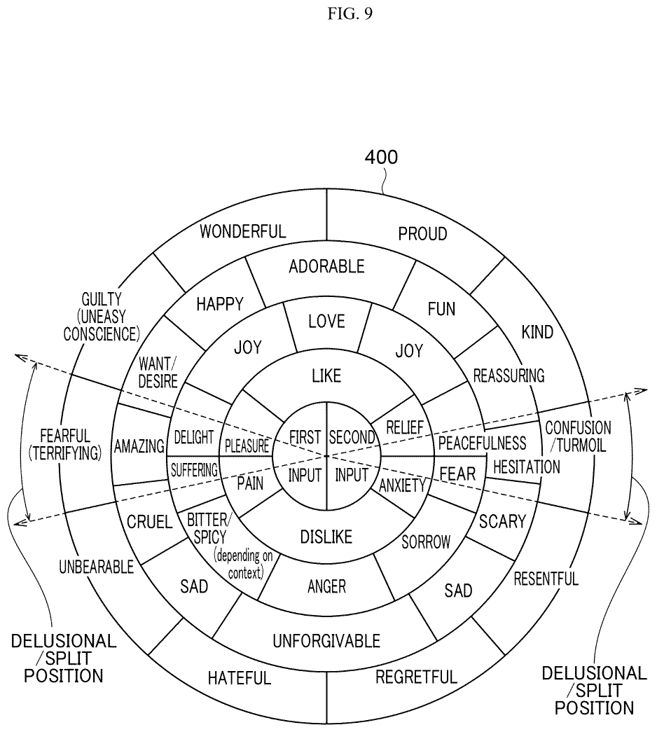

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

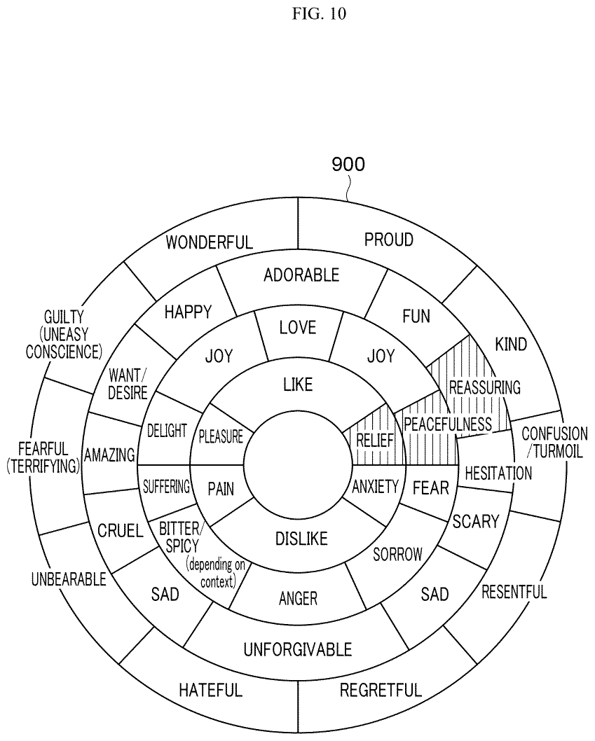

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire input information including a natural language request received from a user via a terminal, and user attribute information and organization attribute information associated with the user; and
generate control information by integrating a prompt sentence including the input information with the user attribute information and the organization attribute information, input the control information to a generative AI model, and obtain structured information including intent information of the request and processing type information corresponding to the request; and
select, on the basis of the processing type information included in the structured information, at least one processing from among schedule management processing, notification control processing, information retrieval processing, work support processing, and job advice processing, and acquire at least one information from among schedule information, communication information, and knowledge information via an information acquisition interface provided by an external information providing apparatus; and
configure a prompt sentence for generation of response data on the basis of the acquired schedule information, communication information, and knowledge information and the user attribute information, and input the prompt sentence to the generative AI model to cause the generative AI model to generate response information in natural language; and
generate display control information to be displayed on the terminal and notification control information to be transmitted to the terminal, on the basis of the response information; and in a management information processing function associated with a higher-level user, aggregate the input information, the structured information, and the response information corresponding to a plurality of users to generate work status index information, and calculate organization-wide characteristic information on the basis of the work status index information; and
estimate emotion state information of the user from the input information by an emotion analysis processing apparatus configured to implement an emotion analysis function, and change contents and expression style of the response information and the notification control information in accordance with the emotion state information.

### (Supplementary 2)

The system according to supplementary 1,
wherein the processor is configured to
generate and provide display control information that enables a higher-level user to obtain, via a management terminal, the work status index information and the organization-wide characteristic information in an overview form.

### (Supplementary 3)

The system according to supplementary 1,
wherein the processor is configured to
cause a plurality of individual artificial intelligence assistant functions respectively associated with a plurality of users to mutually link, in at least one of a work time period and a non-work time period, at least part of the schedule information, work support processing result information, and job advice processing result information, and to extract, as the organization-wide characteristic information, strength information and weakness information of an organization.

### Application Example 1

### (Supplementary 1)

A system comprising a processor,
wherein the processor is configured to
provide, for each of a plurality of users, a personalized artificial intelligence assistant and acquire and organize operation schedule information and inventory information for each user,
generate a prompt sentence to be input to a generative AI model based on the operation schedule information and the inventory information, input the prompt sentence to the generative AI model, and generate advice information for improving work efficiency,
distribute the advice information as notification information to user terminals and acquire response information from the users to the notification information and operation result information,
update learning data of the generative AI model using the acquired response information and the operation result information, and retrain or fine-tune the generative AI model to improve accuracy of generation of the advice information, and
aggregate the acquired operation schedule information, the inventory information, the response information, and the operation result information, and generate aggregate information that indicates an overview of an entire organization's operation status and resource utilization status for a manager.

### (Supplementary 2)

The system according to supplementary 1,
wherein the processor is configured to generate and provide management information based on the aggregate information, the management information enabling a higher-level user to grasp, via the personalized artificial intelligence assistants corresponding to lower-level users, progress statuses of operations and inventory statuses of the lower-level users in an overview manner.

### (Supplementary 3)

The system according to supplementary 1,
wherein the processor is configured to mutually link operation schedule information, inventory information, and advice information among the personalized artificial intelligence assistants corresponding to the plurality of users, generate evaluation information indicating strengths and weaknesses of an organization based on a result of the linking, and provide the evaluation information to a higher-level user.

### Example 2

### (Supplementary 1)

A system comprising a processor,
wherein the processor is configured to
provide, to each user, a personalized information processing assistance function via an information terminal operated by the user,
acquire work progress information and state description information from the information terminal operated by the user, and store the work progress information and the state description information in an information storage unit of a data management apparatus via a communication network,
acquire, from the information storage unit, work progress information and state description information relating to a plurality of users, calculate, for each of the plurality of users, a progress indicator and a delay indicator, and generate aggregated work information based on the progress indicator and the delay indicator,
generate a prompt sentence for input to a generative information processing mechanism from input information including the aggregated work information, cause the generative information processing mechanism to analyze the aggregated work information based on the prompt sentence, and generate analysis result information including work evaluation information and guidance proposal information for a manager,
structure manager-oriented report information based on the analysis result information and the progress indicator and the delay indicator, and generate report information including visualization information and explanatory text information, and
transmit the report information to an information terminal operated by the manager so that the manager can view the report information in real time.

### (Supplementary 2)

The system according to supplementary 1,
wherein the processor is configured to cause the information terminal to automatically transmit, at a predetermined time interval or in response to an operation by the user, the work progress information including at least a task name, a progress rate, a planned completion date, and a free-description work report sentence to the data management apparatus, to update the prompt sentence for the generative information processing mechanism each time the work progress information is transmitted, to regenerate the analysis result information based on the updated prompt sentence, and to sequentially provide updated report information to the information terminal operated by the manager.

### (Supplementary 3)

The system according to supplementary 1,
wherein the processor is configured to, when instruction information or report request information is received from the manager, extract, from the information storage unit, work progress information and state description information corresponding to a predetermined period, dynamically generate a prompt sentence for input to the generative information processing mechanism based on an extraction result, obtain analysis result information in response to the prompt sentence from the generative information processing mechanism, and generate manager-oriented report information that presents, in an overview manner, a work situation, an ability tendency, and a risk factor of a managed group as a whole by using the analysis result information.

### Application Example 2

### (Supplementary 1)

A system comprising a processor,
wherein the processor is configured to
generate, based on task history information and behavior history information for each user, an intelligent assistance function having personalized support capability for each user, and provide the intelligent assistance function to a terminal apparatus associated with the user, and
receive, via the terminal apparatus, at least one prompt sentence including a natural language instruction from the user or from a supervisor and, using a generative AI model, analyze the prompt sentence together with work data associated with the user as input information, and
select or generate a service corresponding to work support processing or equipment control processing based on an analysis result of the generative AI model, and
apply an emotion analysis engine to at least one of voice information, image information, and biometric information acquired from the user to estimate an emotional state of the user, and
adjust service provision by changing, according to the emotional state and the analysis result of the generative AI model, at least one of content of advice, notification timing, and load adjustment content presented by the intelligent assistance function, and
collect sensor data acquired from a plurality of work target machines or facilities, calculate operation status indicators based on the sensor data, convert the operation status indicators into display data for the terminal apparatus, provide the display data as a visual monitoring screen, and input at least one of the prompt sentence and the operation status indicators into the generative AI model so that the generative AI model generates at least one of a production process improvement proposal and a control instruction proposal, and
convert, based on at least one of the control instruction proposal obtained from the generative AI model and an operation instruction received from the user, a high-level work instruction into a control signal in a machine control communication protocol, transmit the control signal to at least one of the work target machines and the facilities, and change an operation condition of the at least one of the work target machines and the facilities, and
integrate work data, the operation status indicators, and the emotional state information relating to a plurality of users and a plurality of the work target machines or facilities, calculate performance indicators for at least one of an organizational unit and a process unit, and input the performance indicators and a prompt sentence from a manager into the generative AI model so that the generative AI model generates an analysis result including at least one of strengths, weaknesses, and improvement measures of at least one of an entire organization and an entire process, and provide the analysis result as a report to the terminal apparatus.

### (Supplementary 2)

The system according to supplementary 1,
wherein the processor is configured to
cause intelligent assistance functions respectively associated with a plurality of users, or a supervisor-side intelligent assistance function and a subordinate-side intelligent assistance function, to automatically exchange, inside and outside working hours, information including at least one of the work data, the operation status indicators, and the emotional state information, and use a result of the information exchange as part of a prompt sentence input to the generative AI model, thereby estimating strengths and weaknesses of an organization and presenting the strengths and weaknesses in an overview form on a terminal apparatus for a manager.

### (Supplementary 3)

The system according to supplementary 1,
wherein the processor is configured to
dynamically generate, based on an estimation result of the emotional state of the user by the emotion analysis engine and an analysis result of the prompt sentence by the generative AI model, a support message including at least one of a break suggestion, a workload reduction suggestion, and a relaxation method for the user, notify the support message to the terminal apparatus, and store, as part of the work data, a response from the user acquired via the terminal apparatus, and reflect the response in at least one of learning and parameter adjustment of the generative AI model and the emotion analysis engine.

What is claimed is:

1. A system comprising:
circuitry configured to:
receive, via a communication interface coupled to a packet-switched network, input information including a natural language request from a terminal device and user attribute information and organization attribute information associated with the user, and store the input information in a storage device;
generate control information by integrating a prompt sentence incorporating the input information, the user attribute information, and the organization attribute information, and input the control information to a generative AI model to select an appropriate service based on an analysis result from the generative AI model; and
evaluate an emotional state of the user based on data received via the communication interface, adjust provision of the selected service based on the evaluated emotional state, and transmit service output to the terminal device via the communication interface.

2. The system according to claim 1, wherein the circuitry is configured to maintain a personalized AI assistant profile for each individual user stored in the storage device, and incorporate the profile into the prompt sentence generated for the generative AI model.

3. The system according to claim 2, wherein the circuitry is configured to update the personalized AI assistant profile based on interaction history and service usage records associated with the user stored in the storage device.

4. The system according to claim 1, wherein the circuitry is configured to receive prompt sentences from a plurality of users via the communication interface, route each prompt sentence to the generative AI model with corresponding user attribute information and organization attribute information, and aggregate analysis results to generate organization-level status information.

5. The system according to claim 4, wherein the circuitry is configured to transmit the organization-level status information to a terminal device associated with a supervisory user via the communication interface to enable the supervisory user to review work situations of subordinate users.

6. The system according to claim 5, wherein the circuitry is configured to generate prompt sentences that instruct the generative AI model to extract strengths and weaknesses of an organization based on the aggregated interaction data, and provide organization analysis results to the supervisory user terminal.

7. The system according to claim 1, wherein the circuitry is configured to evaluate the emotional state of the user by applying an emotion analysis engine to at least one of text content, vocal characteristics, and behavioral patterns in the data received from the terminal device.

8. The system according to claim 7, wherein the circuitry is configured to adjust at least one of a response format, a content depth, and a service priority of the selected service based on the evaluated emotional state.

9. The system according to claim 1, wherein the circuitry is configured to receive, from the terminal device via the communication interface, a natural language request specifying a task, analyze the request using the generative AI model to identify required services from a service registry stored in the storage device, and compose a multi-service response.

10. The system according to claim 9, wherein the circuitry is configured to dynamically select and combine a plurality of services in response to a single natural language request based on output of the generative AI model.

11. The system according to claim 1, wherein the circuitry is configured to record interaction history between the user and the generative AI model in the storage device, and use the recorded interaction history to generate personalized prompt sentences for subsequent requests from the user.

12. The system according to claim 11, wherein the circuitry is configured to detect changes in the user attribute information over time based on the recorded interaction history, and update the control information generated for the generative AI model to reflect the detected changes.

13. The system according to claim 1, wherein the circuitry is configured to receive, from a plurality of terminal devices via the communication interface, natural language requests associated with a plurality of users, and independently maintain personalized generative AI model configurations for each user.

14. The system according to claim 13, wherein the circuitry is configured to aggregate interaction data across a plurality of users to detect organization-level patterns, generate a prompt sentence instructing the generative AI model to identify organizational strengths and weaknesses, and transmit the analysis results to a designated terminal device.

15. The system according to claim 1, wherein the circuitry is configured to receive, from the terminal device, feedback on service output provided to the user, incorporate the feedback into the user attribute information stored in the storage device, and update the prompt sentence used for subsequent service selection.

16. The system according to claim 1, wherein the circuitry is configured to monitor the emotional state of the user continuously during a session based on data received from the terminal device, and dynamically modify the selected service in response to detected changes in the emotional state.

17. The system according to claim 16, wherein the circuitry is configured to store a time-stamped record of emotional state transitions for the user in the storage device, and use the stored record to adapt prompt sentences for the generative AI model to account for emotional context patterns.

18. A system comprising:
circuitry configured to:
receive, via a communication interface coupled to a packet-switched network, input information including a natural language request and user attribute information from a terminal device, and store the input information in a storage device;
generate a prompt sentence incorporating the natural language request, the user attribute information, and organization attribute information, input the prompt sentence to a generative AI model, and select an appropriate service based on an analysis result from the generative AI model;
evaluate an emotional state of the user based on data received from the terminal device via the communication interface, and adjust provision of the selected service based on the evaluated emotional state; and
transmit service output to the terminal device via the communication interface, and update the user attribute information in the storage device based on interaction history.

19. The system according to claim 18, wherein the circuitry is configured to aggregate interaction data from a plurality of users associated with an organization, generate a prompt sentence instructing the generative AI model to identify organizational strengths and weaknesses based on the aggregated data, and transmit analysis results to a supervisory terminal device via the communication interface.

20. A method comprising:
receiving, via a communication interface coupled to a packet-switched network, input information including a natural language request from a terminal device and user attribute information and organization attribute information, and storing the input information in a storage device;
generating control information by integrating a prompt sentence incorporating the input information, the user attribute information, and the organization attribute information, and inputting the control information to a generative AI model to select an appropriate service based on an analysis result from the generative AI model; and
evaluating an emotional state of the user based on data received via the communication interface, adjusting provision of the selected service based on the evaluated emotional state, and transmitting service output to the terminal device via the communication interface.
